(19) United States
(12) Patent Application Publication
(10) Pub. No.: US 2026/0219596 A1
(43) Pub. Date: Jul. 30, 2026

(54) ELECTROSTATIC CHARGE IMAGE DEVELOPING TONER

(71) Applicant: Konica Minolta, Inc., Tokyo (JP)

(72) Inventors: Kentarou MOGI, Tokyo (JP); Ikuko SAKURADA, Tokyo (JP); Ito KOGA, Tokyo (JP)

(21) Appl. No.: 19/451,046

(22) Filed: Jan. 16, 2026

(30) Foreign Application Priority Data
Jan. 27, 2025 (JP) 2025-011199

(51) Int. Cl. G03G 9/093; G03G 9/087

(52) U.S. Cl. CPC G03G 9/09342; G03G 9/08755

(57) ABSTRACT

An electrostatic charge image developing toner of the present invention includes toner base particles including a binder resin and a wax, and an external additive adhered to a surface of the toner base particles. The binder resin includes a crystalline polyester resin and the amorphous resin. The external additive includes inorganic particles surface-treated with a surface treating agent. The inorganic particles have a hydrophobization degree of 80% or more. The HSP value (HSP1) of the wax and the HSP value (HSP2) of the surface treating agent satisfy the following expression (A): HSP1−HSP2≥2.7 . . . Expression (A).

### CROSS REFERENCE TO RELATED APPLICATIONS

The entire disclosure of Japanese Patent Application No. 2025-011199 filed on Jan. 27, 2025, is incorporated herein by reference in its entirety.

### BACKGROUND

### Technological Field

The present invention relates to an electrostatic charge image developing toner.

### Description of Related Art

In electrophotographic method image formation, in recent years, there has been an increasing demand for low-temperature fixing in order to achieve further energy saving for the purpose of increasing printing speed, reducing environmental load, and the like. In the toner used for such a purpose, it is required to lower the melting temperature and the melt viscosity of the binder resin, and a technique has been proposed in which a crystalline resin such as a crystalline polyester resin is added to improve the low-temperature fixability.

For example, Japanese Unexamined Patent Publication No. 2004-206081 discloses a toner for image formation containing at least a thermo-plastic resin (A), a coloring agent (B), a wax (C) and a crystallizable polymer (D). Such an image forming toner is said to have enhanced low-temperature fixability.

However, according to the findings of the present inventors, the image forming toner described in Japanese Unexamined Patent Publication No. 2004-206081 was unsatisfactory from the viewpoint of preventing the gloss unevenness of the obtained image.

### SUMMARY

An object of the present invention is to provide an electrostatic charge image developing toner that can achieve both low-temperature fixability and suppression of gloss unevenness of an obtained image.

To achieve at least one of the abovementioned objects, an electrostatic charge image developing toner reflecting one aspect of the present invention includes the following: toner base particles including a binder resin and a wax; and an external additive adhered to a surface of the toner base particles, in which the binder resin includes a crystalline polyester resin and an amorphous resin, the external additive includes inorganic particles surface-treated with a surface treating agent, a hydrophobization degree of the inorganic particles is 80% or more, and an HSP value (HSP1) of the wax and an HSP value (HSP2) of the surface treating agent satisfy the following expression (A):

$$HSP 1 - HSP 2 \geq 2.7 . \qquad Expression ( A )$$

### DETAILED DESCRIPTION OF EMBODIMENTS

The advantageous and features provided by one or more embodiments of the invention will become more fully understood from the detailed description given hereinbelow, and thus are not intended as a definition of the limits of the present invention:

Hereinafter, one or more embodiments of the present invention will be described. However, the scope of the invention is not limited to the disclosed embodiments.

Note that in the present specification, a numerical range indicated by using “to” means a range including numerical values described before and after “to” as a lower limit value and an upper limit value.

In addition, in the present specification, “(meth)acrylate” means any one or both of acrylate and methacrylate, and “(meth)acryl” means any one or both of acryl and methacryl.

### 1. Electrostatic Charge Image Developing Toner

The electrostatic charge image developing toner (hereinafter, also simply referred to as “toner”) according to the present embodiment includes the following:
a toner base particle containing a binder resin, a coloring agent, and a wax; and
an external additive adhering to a surface of the toner base particle.

The binder resin contains a crystalline polyester resin and the amorphous resin,
the external additive contains an inorganic particle surface-treated with a surface treating agent,
a hydrophobization degree of the inorganic particle is 80% or more, and
an HSP value (HSP1) of the wax and an HSP value (HSP2) of the surface treating agent satisfy the following expression (A):

$$HSP 1 - HSP 2 \geq 2.7 . \qquad Expression ( A )$$

When the toner base particle contains a crystalline polyester, the crystalline polyester and the amorphous resin are compatible with each other. As a result, the melting point is decreased, and the glass transition temperature, melting temperature, and melt viscosity of the binder resin are more likely to be decreased.

On the other hand, when printing is performed on a recording medium using toner, the toner applied to the recording medium undergoes a fixing step. In the fixing step, the toner applied to the recording medium is heated so that the binder resin and the like melt and the unfixed image is fixed on the recording medium. At this time, the wax contained in the toner base particles exudes to the surface of the toner, and the releasability between the fixing roller and the image on the recording medium is exhibited. At this time, when part of the binder resin is not completely melted on the surface of the image due to uneven dispersion of the crystalline polyester in the toner base particles, uneven temperature of the fixing device, or the like, the surface of the fixed binder resin tends to be uneven; however, the wax exudes sufficiently and covers the outermost layer of the image, the smoothness becomes relatively high. However, the amount of wax exuded is not uniform over the entire surface of the binder resin, and the amount of exuded wax may be uneven among places. Then, the smoothness is enhanced and the light scattering properties are reduced in the portion where the wax exudes in a large amount, and the smoothness is less likely to increase and the light scattering properties are less likely to decrease in the portion where the wax exudes in a small amount. As a result, it is considered that gloss unevenness of an image tends to occur.

According to the above electrostatic charge image developing toner, even when the low-temperature fixability is enhanced, suppression of gloss unevenness of an obtained image can be achieved at the same time. The reason for this is not entirely clear, but it can be considered as follows.

The toner according to the present embodiment contains an external additive for imparting chargeability and fluidity to the surface of the toner base particles, and the external additive contains inorganic particles surface-treated with a surface treating agent. In a case where the wax exudes from the surface of the toner in the fixing step, when the surface treating agent has a small HSP value (the hydrophobicity is higher) as compared to the hydrophobicity of the wax, the inorganic particles contained in the external additive tend to move to the more hydrophobic air interface side. Therefore, the inorganic particles tend to be transported to the outermost surface of the image. In this case, the inorganic particles are more likely to be distributed at a high amount on the outermost surface of the wax. As a result of the inorganic particles being distributed at a high amount on the outermost surface of the wax, the waxes tend to aggregate with each other and the inorganic particles tend to aggregate with each other, resulting in a portion where the inorganic particles are distributed at a high amount and a portion where the inorganic particles are distributed at a low amount (portions where the wax is present in a higher proportion) within the plane. As a result, an in-plane difference occurs in the surface tension of the wax, and unevenness is more likely to be moderately generated on the surface of the wax. Even when the amount of wax exuded to the toner surface is increased as described above and the wax covers the outermost surface of the toner, the smoothness is less likely to be increased compared to a case where the wax does not cover the outermost surface of the toner. As a result, even when the amount of wax exuded varies within the plane of the image, gloss unevenness is less likely to occur in the image.

In particular, when the HSP value (HSP1) of the wax and the HSP value (HSP2) of the surface treating agent satisfy the following expression (A), the hydrophobicity of the surface treating agent is sufficiently enhanced relative to the hydrophobicity of the wax, and thus the compatibility between the wax and the surface treating agent is also reduced. As a result, the inorganic particles are more likely to be distributed at a high amount on the outermost surface of the toner, and the above-described effect of preventing gloss unevenness is more likely to be enhanced.

$$HSP 1 - HSP 2 \geq 2.7 \qquad Expression ( A )$$

In addition, when the hydrophobization degree of the inorganic particles is 80% or more, since the surfaces of the inorganic particles can be sufficiently coated with the surface treating agent, the inorganic particles are more likely to be distributed at a high amount on the outermost surface of the toner, and thus, the above-described effect of preventing gloss unevenness is more likely to be enhanced.

Thus, it is considered that both low-temperature fixability and suppression of gloss unevenness of an obtained image are achieved.

Note that the HSP value (HSP1) of the wax and the HSP value (HSP2) of the surface treating agent in the present application are values calculated as follows. The HSP value is a value calculated by the method of Hansen. Hansen solubility parameters (δD, δP, δH) of each compound are calculated by inputting the chemical structures of the compounds to be calculated in the molecular linear notation Smiles equation using HSPiP (Ver. 6.0.04). From these values, the HSP values (HSP1 and HSP2) of each compound are calculated by calculating (δD²+δP²+δH²) 0.5.

### 1-1. External Additive

The external additive includes inorganic particles surface-treated with a surface treating agent.

### 1-1-1. Inorganic Particle

Examples of the inorganic particles include particles of silica and metal oxide such as alumina and titanium oxide, and particles of titanate such as strontium titanate and zinc titanate, and among these, silica is preferable from the viewpoint of fluidity, chargeability, and the like.

In particular, when silica is used as the inorganic particles, silica produced by a known method or commercially available silica is used, and among these, monodispersed spherical silica is preferable. The reason for this is that since the particles are monodisperse and spherical, the particles are uniformly dispersed on the surface of the toner base particles and the effect of preventing gloss unevenness is easily enhanced. The monodispersed spherical silica can be produced by a sol-gel method or the like, which is a wet method. The dispersibility and shape (spherical, non-spherical, or the like) of silica can be freely controlled by manufacturing conditions such as hydrolysis in the sol-gel method, weight ratios of alkoxysilane, ammonia, alcohol, and water in the polycondensation step, reaction temperature, stirring rate, and feed rate.

In addition, the inorganic particles can be produced by a known method, and may be produced by a fumed method. For example, silica produced by a fumed method (hereinafter, also referred to as “fumed silica”) can be produced by introducing a silicon compound (silicon tetrachloride or the like) or silicon into an oxygen-hydrogen flame and subjecting it to a hydrolysis reaction. As the inorganic particles produced by a fumed method, commercially available products may be used.

### 1-1-2. Surface Treating Agent

As the surface treating agent used for the surface treatment of the inorganic particles, a known hydrophobic surface treating agent can be used. Examples of the surface treating agent include silicone oil, hexamethyldisilazane, dichlorodimethylsilane, and alkyltrialkoxysilane. Among these, the surface treating agent preferably contains silicone oil, and more preferably is silicone oil.

The silicone oil used as the surface treating agent may be a reactive silicone oil, a non-reactive silicone oil, or a mixture thereof. The inorganic particle surface-treated with a surface treating agent according to the present embodiment may have a multilayer structure including a coating layer formed of the surface treating agent on the surface of the inorganic particle, or may have a single-layer structure. The coating layer may have a single-layer structure or a multilayer structure. For example, the coating layer may be a coating layer formed only of reactive silicone oil, a coating layer formed only of non-reactive silicone oil, or a coating layer containing a component in addition to silicone oil. The coating layer may be a coating layer formed of a reactive silicone oil and a non-reactive silicone oil, or may be a coating layer having a multilayer structure including a coating layer formed of a reactive silicone oil and a coating layer formed of a non-reactive silicone oil. In the case of a coating layer having a multilayer structure, for example, the coating layer may be a coating layer having a two layer structure composed of a coating layer formed from a reactive silicone oil and a coating layer formed from a non-reactive silicone oil, and either of the coating layers may be the outermost surface.

The main chain (main skeleton) having siloxane bonds contained in the silicone oil is not particularly limited, but preferably has dimethylsiloxane constitutional units, and more preferably composed of dimethylsiloxane constitutional units.

The silicone oil may be a modified silicone oil. Examples of modified silicone oils include amino-modified silicone oil, epoxy-modified silicone oil, carboxyl-modified silicone oil, carbinol-modified silicone oil, methacrylic-modified silicone oil, mercapto-modified silicone oil, phenol-modified silicone oil, both-terminal silanol dimethyl oil, one-terminal reactive modified silicone oil, heterofunctional group-modified silicone oil, polyether-modified silicone oil, higher fatty acid ester-modified silicone oil, special hydrophilic modified silicone oil, higher alkoxy-modified silicone oil, higher fatty acid-containing modified silicone oil, and fluorine-modified silicone oil.

### 1-1-2-1. Reactive Silicone Oil

The reactive silicone oil has a reactive functional group at a terminal of a main chain formed of a siloxane bond and/or a side chain. From the viewpoint of facilitating an increase in reactivity with the surface of the inorganic particles and an increase in the hydrophobization degree, the silicone oil preferably includes a reactive silicone oil, and more preferably is a reactive silicone oil. The ratio of the reactive silicone oil to the total mass of the surface treating agent used for forming the coating layer can be 90% by mass to 100% by mass.

Examples of reactive functional groups contained in the reactive silicone include Si—H moieties (hydrogen atoms directly bonded to silicon), hydroxyl group, amino group, carbinol group, epoxy group, and carboxyl group.

Among these, in the case where the inorganic particles include an inorganic oxide particle or in the case where the surface of the inorganic particles is partially oxidized, from the viewpoint of reacting with a hydroxy group on the surface of the inorganic particles to be easily bonded, the reactive silicone preferably include a hydroxy group as the reactive functional group. For example, when the inorganic particle is silica, an Si—O—Si bond can be formed by a reaction between Si—OH on the surface of the silica and a hydroxy group contained in the functional group.

Furthermore, the reactive silicone oil preferably contains silanol-terminated dimethylpolysilicone and/or methyl hydrogen polysilicone, and more preferably composed of silanol-terminated dimethylpolysilicone and/or methyl hydrogen polysilicone.

The silanol-terminated dimethylpolysilicone is, for example, a compound represented by the following formula (1).

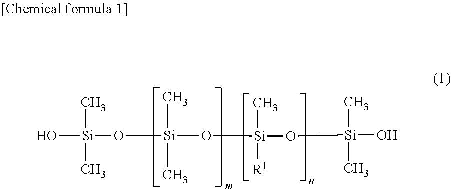

In the above formula (1), R¹ represents an organic group other than methyl, m represents an integer of 1 or more, and n represents 0 or an integer of 1 or more. R¹ is preferably a hydrocarbon group having 2 or more carbon atoms, and more preferably a hydrocarbon group having 2 to 6 carbon atoms. The repeating units —(Si(CH₃)₂—O)— and —(SiR¹(CH₃)—O) are not limited to those obtained by block copolymerization, and the silanol-terminated dimethylpolysilicone may be an alternating copolymer, a random copolymer, or a block copolymer.

A reactive silicone oil having hydroxyl groups at both ends of polydimethylsiloxane and n is 0 in the above formula (1) may also be suitably used. In addition, the polydimethylsiloxane may have a hydroxyl group at one terminal thereof, and it is sufficient that the polydimethylsiloxane has at least one hydroxyl group at a terminal thereof.

The methyl hydrogen polysilicone may be any compound having a hydrogen atom in a side chain of the siloxane chain, and examples thereof include a compound represented by the following formula (2).

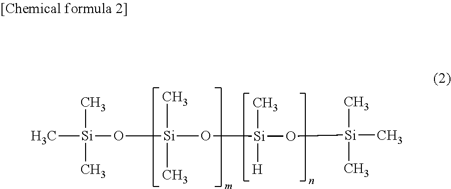

In the above formula (2), m represents 0 or an integer of 1 or more, and n represents an integer of 1 or more. In addition, m+n≥1. The repeating units —(Si(CH₃)₂—O)— and —(SiR¹(CH₃)—O) are not limited to those block-copolymerized, and the methyl hydrogen polysilicone may be an alternating copolymer, a random copolymer, or a block copolymer.

These reactive silicone oils may be produced by known methods, or may be commercially available products. The reactive silicone oil may be used alone or in combination of two or more.

The kinematic viscosity (measurement temperature 25° C.) (hereinafter referred to as “viscosity”) of the reactive silicone oil is not particularly limited, but is preferably 30 cSt to 100 cSt. When the viscosity is 30 cSt or more, since the molecular weight becomes large, the volatilization of the reactive silicone oil during the heat treatment is reduced, the surface treatment easily proceeds sufficiently, and the environmental load can also be reduced. On the other hand, when the viscosity is equal to or less than the 100 cSt, the aggregation of the inorganic particles is easily reduced, and the fluidity is easily enhanced. The kinematic viscosity is a value measured by, for example, ARES-TA (manufactured by G2 Instruments Inc).

In addition, the range of the weight-average molecular weight of the reactive silicone oil is preferably 1000 to 20000, and more preferably 3000 to 10000. When the weight-average molecular weight is 1000 or more, the heat-resistant storage property of the toner is easily enhanced, and when the weight-average molecular weight is 20000 or less, the viscosity of the surface treating agent is appropriately adjusted, and thus the inorganic particles surface-treated with the surface treating agent are more likely to be distributed at a high amount on the wax surface, and the effect of preventing gloss unevenness is easily enhanced. The weight-average molecular weight is a value measured by gel permeation chromatography (GPC).

To be specific, an apparatus “HLC-8120GPC” (manufactured by Tosoh Corporation) and a column “TSK guard column+TSKgel SuperHZ-M3 series” (manufactured by Tosoh Corporation) are used. The measurement conditions were a column temperature of 40° C., a carrier-solvent of tetrahydrofuran (THF), and a carrier-solvent flow rate of 0.2 ml/min. A measurement sample (amorphous resin) is dissolved in tetrahydrofuran so as to have a concentration of 1 mg/ml under dissolution conditions in which the sample is treated for 5 minutes using an ultrasonic disperser at room temperature. The tetrahydrofuran solution of the measurement sample is treated with a filter having a pore size of 0.2 μm. This sample solution (10 μL) is injected into the device together with the above-described carrier solvent, and the detection is performed using a refractive index detector (RI detector). The weight-average molecular weight and the number-average molecular weight of the measurement sample can be calculated as polystyrene equivalent values using a calibration curve created using 10 samples of monodispersed polystyrene standard particles.

The content of the reactive silicone oil is not particularly limited, but is preferably 1% by mass to 15% by mass, more preferably 2% by mass to 12% by mass, and still more preferably 3% by mass to 10% by mass based on the total mass of the inorganic particles. When the content of the reactive silicone oil is 1% by mass or more, the hydrophobization degree is easily increased, and the hydrophobization degree of the inorganic particles is easily increased. When the content of the reactive silicone oil is 15% by mass or less, the aggregation of the inorganic particles is easily reduced, and the fluidity is easily maintained.

### 1-1-2-2. Non-Reactive Silicone Oil

The non-reactive silicone oil may be any oil that does not have the above-described reactive functional groups, and for example, may be polydimethylsiloxane, or may be polysiloxane having an alkyl group other than methyl group, an aralkyl group, a polyether group, a fluoroalkyl group, an ester group, a phenyl group, or the like in a side chain. These non-reactive silicone oils may be produced by known methods, or may be commercially available products. The non-reactive silicone oil may be used alone or in combination of two or more.

The kinematic viscosity (measurement temperature 25° C.) (hereinafter, referred to as “viscosity”) of the non-reactive silicone oil is not particularly limited, but is preferably 30 cSt to 100 cSt. When the viscosity is 30 cSt or more, since the molecular weight becomes large, volatilization of the non-reactive silicone oil during heat treatment is reduced, and the environmental load can also be reduced. On the other hand, when the viscosity is equal to or less than the 100 cSt, the aggregation of the inorganic particles is easily reduced, and the fluidity is easily enhanced. The kinematic viscosity is a value measured in the same manner as in the method described above.

Furthermore, the weight-average molecular weight of the non-reactive silicone oil is preferably in a range of 1000 to 20000, and more preferably in a range of 3000 to 10000. When the weight-average molecular weight is 1000 or more, the heat-resistant storage property of the toner is easily enhanced, and when the weight-average molecular weight is 20000 or less, the viscosity of the surface treating agent is appropriately adjusted, and thus the inorganic particles surface-treated with the surface treating agent are more likely to be distributed at a high amount on the wax surface, and the effect of preventing gloss unevenness is easily enhanced. The weight-average molecular weight is a value measured in the same manner as in the method described above.

The content of the non-reactive silicone oil is not particularly limited, but is preferably 1% by mass to 15% by mass, more preferably 2% by mass to 12% by mass, and still more preferably 3% by mass to 10% by mass based on the total mass of the inorganic particles. When the content of the non-reactive silicone oil is 1% by mass or more, the hydrophobization degree is easily increased, and the hydrophobization degree of the inorganic particles is easily increased. When the content of the nonreactive silicone oil is 15% by mass or less, the aggregation of the inorganic particles is easily reduced, and the fluidity is easily maintained.

The mass ratio of the reactive silicone oil to the non-reactive silicone oil in the surface treating agent is not particularly limited, but is desirably 0.2:1.0 to 4.0:1.0. When the ratio is set as such, the fluidity tends to increase, and the chargeability tends to be adjusted.

### 1-1-2-3. Characteristics of Surface Treating Agent

When a component other than the silicone oil is used as the surface treating agent, the weight-average molecular weight of the surface treating agent is preferably 1000 to 20000. When the weight-average molecular weight is 1000 or more, the heat-resistant storage property of the toner is easily enhanced, and when the weight-average molecular weight is 20000 or less, the viscosity of the surface treating agent is appropriately adjusted, and thus the inorganic particles surface-treated with the surface treating agent are more likely to be distributed at a high amount on the wax surface, and the effect of preventing gloss unevenness is easily enhanced. The weight-average molecular weight is a value measured in the same manner as in the method described above.

### 1-1-3. Characteristics of External Additive

The particle diameter of the inorganic particles included in the external additive is not particularly limited, but the primary particle diameter is preferably 5 nm to 150 nm, more preferably 10 nm to 150 nm, even more preferably 10 nm to 120 nm, and even more preferably 20 nm to 80 nm. When the primary particle diameter is 5 nm or more, in the case where the particles are distributed at a high amount in the vicinity of the surface of the toner, surface unevenness is more likely to be appropriately formed, and the effect of preventing gloss unevenness is more likely to be enhanced. In addition, when the primary particle diameter is 20 nm or more, surface unevenness is more likely to be appropriately formed in the portion where the inorganic particles are distributed at a high amount, and thus the effect of preventing gloss unevenness is more likely to be enhanced. In addition, heat-resistant storage property is also easily enhanced. When the primary particle size is equal to or less than 150 nm, the mobility of the inorganic particles is more likely to increase, uneven distribution on the toner surfaces is more likely to occur, and the effect of preventing gloss unevenness is more likely to increase. When the primary particle diameter is 80 nm or less, the fluidity is easily enhanced. The particle diameter is, for example, a value obtained by arithmetically averaging particle diameters of 1000 particles arbitrarily selected by observation with a transmission electron microscope (TEM).

The inorganic particles contained in the external additive preferably have a specific surface area measured by a nitrogen-adsorption method (BET) (hereinafter, also referred to as “BET specific surface area”) of 10 m²/g to 10⁴ m²/g, more preferably 20 m²/g to 10² m²/g. When the BET specific surface area is equal to or greater than 10 m²/g, the fluidity of the toner is easily increased. When the BET specific surface area is equal to or less than 10⁴ m²/g, the particles are less likely to be embedded in the toner base particle, and the toner properties are more likely to be more stable over time. The BET specific surface area is a value measured by, for example, an automatic specific surface area-measuring apparatus GEMINI 2360 (manufactured by Shimazu Micromeritics Co., Ltd).

The hydrophobization degree of the inorganic particles contained in the external additive is 80% or more, preferably 80% to 100%, more preferably 90% to 100%. When the hydrophobization degree is 80% or more, the chargeability particularly under high temperature and high humidity is more likely to be enhanced, and the inorganic particles are more likely to be distributed at a high amount on the surface. Therefore, the effect of preventing gloss unevenness is more likely to be enhanced.

Note that the hydrophobization degree of the inorganic particles is a value measured as follows. For example, pure water is added to inorganic particles that have been surface-treated with a surface treating agent, and the dispersion liquid is subjected to a dispersion treatment. The transmittance at a wavelength of 500 nm measured with a colorimeter or the like can be used as the hydrophobization degree. This utilizes the fact that inorganic particles sufficiently surface-treated with a surface treating agent are precipitated in water or are floated on the water surface without being dispersed, so that the turbidity of the dispersion liquid is less likely to increase and facilitating an increase in the visible light transmittance of the dispersion liquid. Note that in the case where the external additive includes two or more types of surface-treated inorganic particles, the hydrophobization degree of the inorganic particles in the present application refers to the hydrophobization degree of the inorganic particles having the highest content on a mass basis. In addition, in the case where there are two or more types of inorganic particles having the highest content on a mass basis, the hydrophobization degree refers to a value obtained by averaging the respective hydrophobization degrees corresponding to the plurality of inorganic particles having the highest content on a mass basis.

Specifically, 1.0 g of inorganic particles is weighed and placed in a 200 mL separatory funnel, and 100 mL of pure water is added thereto, followed by shaking for 10 minutes in a turbulent mixer. After the shaking, the mixture is left to stand for 10 minutes, 20 to 30 mL of a liquid in the lower layer is removed from the funnel, and then the liquid in the lower layer is collected in a silica cell having an optical path length of 10 mm. The transmittance of light with a wavelength of 500 mm is determined by measuring with a colorimeter using pure water as a blank, and the transmittance may be used as the hydrophobization degree.

In a case where the surface treating agent is a silicone oil, the content of the free silicone oil with respect to the content mass of the inorganic particles subjected to the surface treatment is preferably 1 ppm to 15000 ppm, more preferably 1 ppm to 10000 ppm, and even more preferably 1 ppm to 5000 ppm. The content is most preferably 1 ppm to 1000 ppm. When the content ratio of the free silicone oil is 1 ppm or more, the free oil serves as a lubricant in a step of cleaning the toner remaining on a photoreceptor drum performing image formation, thereby stabilizing the behavior of the cleaning blade and facilitating improvement of the cleaning performance. In addition, the effect of preventing gloss unevenness is easily enhanced. When the content ratio of the free silicone oil is less than or equal to 15000 ppm, when the wax exudes in a fixing step, part of the silicone oil contained in the external additive is less likely to diffuse into the wax, and the compatibility between the wax and the inorganic particles is less likely to increase. As a result, the inorganic particles are more likely to be distributed at a high amount on the surface, and the effect of preventing gloss unevenness is more likely to be enhanced. In addition, the heat-resistant storage property and the fluidity of the toner are also easily enhanced. In a case where two or more types of surface-treated inorganic particles are included in the external additive, the content of the free silicone oil in the present application refers to the content mass ratio of the free silicone oil included in the inorganic particles having the highest content on a mass basis to the mass of the inorganic particles having the highest content on a mass basis. In addition, in the case where there are two or more types of inorganic particles having the highest content on a mass basis, the content of free silicone oil refers to an average value of the respective contents of free silicone oil corresponding to the plurality of inorganic particles having the highest content on a mass basis.

The content of the free silicone oil with respect to the content mass of the inorganic particles having been surface treated (herein, also referred to as “surface-treated inorganic particles”) is a value measured as follows. The surface-treated inorganic particles are immersed in an organic solvent (e.g., hexane), and the silicone oil that has not reacted with the inorganic particles (free silicone oil) is extracted. The carbon contents of the surface-treated inorganic particles before and after the extraction operation are analyzed using a known carbon analyzer (for example, “EMIA-110” manufactured by Horiba, Ltd.). The value obtained by subtracting the carbon content of the surface-treated inorganic particles after the extraction operation from the carbon content of the surface-treated inorganic particles before the extraction operation can be regarded as the content of free silicone oil based on the total amount of the surface-treated inorganic particles.

To be specific, for example, a Soxhlet extractor manufactured by Buchi Labortechnik AG is used, 0.5 g of the external additive is put into a 28 mm-diameter cylindrical filter paper, hexane is used as an extractant, and free silicone oil in the external additive is extracted under the conditions of an extraction time of 60 minutes and a rinsing time of 30 minutes. The carbon contents of the external additive before and after extraction are measured using “EMIA-110” manufactured by Horiba, Ltd. The content of the free silicone oil based on the total amount of the external additive can be calculated by subtracting the carbon content of the external additive after extracting and removing the free silicone oil from the carbon content of the external additive before extraction.

In order to improve fluidity, chargeability, cleaning performance, and the like, the toner base particles may or may not contain an external additive, such as a so-called fluidizer or cleaning aid. The external additive may be composed of inorganic particles surface-treated with a surface treating agent.

The content of the inorganic particles, having been surface-treated with the surface treating agent and included in the external additive, is preferably from 0.1% by mass to 4.5% by mass, more preferably from 0.3% by mass to 3.0% by mass, and more preferably from 1.0% by mass to 2.0% by mass, based on the total mass of the toner base particles. When the content of the external additive is 0.1% by mass or more, the coverage of the toner base particle with the external additive is more likely to increase, the fluidity is more likely to increase, and the effect of preventing gloss unevenness is more likely to increase. When the content is 0.3% by mass or more, the fluidity is more likely to increase. When the content is 4.5% by mass or less, the coverage is not excessively increased, fusion between the toner base particles at the time of fixing is easily advanced, and the low-temperature fixability is easily enhanced.

1-1-4. Method for Producing Inorganic Particles Surface-Treated with Surface Treating Agent

The inorganic particles surface-treated with a surface treating agent can be produced by a known method.

In particular, when the surface treating agent is silicone oil, the inorganic particles can be produced by, for example, a method including the following steps.
(I) a step of preparing a mixture containing inorganic particles and silicone oil (preparation step)
(ii) subjecting the mixture to heat treatment at a temperature of 80 to 380° C. (heat treatment step)

### 1-1-4-1. (i) Preparation Step

The preparation step may use any method as long as the method can coat the surface of the inorganic particles with the silicone oil. For example, a method in which inorganic particles and vaporized silicone oil are mixed under stirring, a method in which silicone oil is sprayed onto inorganic particles under stirring, or the like can be suitably used.

In this case, the silicone oil may be used after being diluted or dispersed in hexane, toluene, an alcohol (an aliphatic alcohol having 1 to 8 carbon atoms, such as methanol, ethanol, or propanol), acetone, water, or a mixture thereof. The concentration of the silicone oil in the diluted or dispersion liquid can be 5% by mass to 70% by mass based on the total mass of the liquid.

Temperature conditions in the preparation step are not particularly limited, and can be, for example, 10° C. to 40° C. Furthermore, the preparation step is preferably performed under an inert gas atmosphere, and examples of the inert gas include nitrogen gas, helium gas, argon gas and the like.

### 1-1-4-2. (ii) Heat Treatment Step

The temperature condition in the heat treatment step is not particularly limited, but is preferably 80° C. to 380° C., more preferably 150° C. to 380° C., and further preferably 280° C. to 380° C. When the temperature is 80° C. or more, the reaction of the silicone oil with the inorganic particles is more likely to proceed, the hydrophobization degree is more likely to increase, and the amount of free silicone oil described later is more likely to decrease. When the temperature is 380° C. or lower, decomposition of the silicone oil is easily reduced, and the coating effect of the silicone oil is easily obtained.

The heat treatment step is preferably performed under an inert gas atmosphere, and examples of the inert gas include nitrogen gas, helium gas, argon gas and the like. In particular, the preparation step may be performed in a sealed reactor, and the heat treatment step may be performed while maintaining the above-described atmosphere.

The treatment time in the heat treatment step may be any time that is sufficient for the silicone oil to be fixed to the surface of the inorganic particles, and may be from 5 minutes to 180 minutes.

### 1-2. Toner Base Particle

The toner base particle according to the present embodiment contains a binder resin, a crystalline polyester, and a wax. The toner base particles according to the present embodiment preferably contain a coloring agent.

### 1-2-1. Wax

The wax according to the present embodiment is not particularly limited as long as the HSP value (HSP1) of the wax and the HSP value (HSP2) of the surface treating agent satisfy the following expression (A). Note that each HSP value is a value calculated by the same method as described above.

$$HSP 1 - HSP 2 \geq 2.7 . \qquad Expression ( A )$$

When two or more types of waxes are contained, the HSP value of the wax having the highest content on a weight basis among the two or more types of waxes is used as HSP1. Similarly, in the case where two or more types of surface treating agents are contained, the HSP value of the surface treating agent having highest content on a mass basis among the two or more types of surface treating agents is used as HSP2. Furthermore, when there are two or more types of waxes with the highest content on a mass basis, HSP1 refers to the average value of the HSP1s corresponding to the waxes with the highest content on a mass basis, and HSP2 refers to the average value of the HSP2s corresponding to the surface treating agents with the highest content on a mass basis.

The value of HSP1−HSP2 is 2.7 or more, preferably 3.5 or more, and more preferably 4.0 or more. In addition, the value of HSP1−HSP2 is preferably 5.0 or less. When the value is 3.5 or more, the inorganic particles are more likely to be distributed at a high amount on the air interface side, and thus gloss unevenness is more likely to be prevented. When the number-average molecular weight is 5.0 or less, the polarity of the wax does not become excessively high and the compatibility with the binder resin and the like decreases to an appropriate degree, so that the glass transition temperature of the binder resin is less likely to decrease and the heat-resistant storage property tends to increase.

Examples of waxes that satisfy expression (A) include waxes into which a functional group containing an oxygen atom or a nitrogen atom has been appropriately introduced to appropriately increase polarity. Examples of the functional group containing an oxygen atom or a nitrogen atom include ester group, amide group, carboxy group, hydroxy group, and ether group.

In addition, the wax is preferably a compound having a long-chain hydrocarbon group so as to have low compatibility with the fixing resin, the crystalline polyester, or the like, from the viewpoint of allowing the wax to easily exude from the toner base particles in the fixing step. By doing so, the compatibility with a resin having a relatively high polarity, such as polyester, is appropriately lowered, and therefore the wax is more likely to exude from the toner base particle. Examples of the long-chain hydrocarbon include aliphatic hydrocarbons having 12 to 34 carbon atoms.

Examples of the wax include the following:
esters of monohydric alcohols and aliphatic monocarboxylic acids, such as behenyl behenate, stearyl stearate, and palmityl palmitate, or esters of monocarboxylic acids and aliphatic monoalcohols;
esters of dihydric alcohols and aliphatic monocarboxylic acids, such as dibehenyl sebacate or hexanediol dibehenate; or esters of dicarboxylic acids and aliphatic monoalcohols;
esters of trihydric alcohols and aliphatic monocarboxylic acids, such as glycerin tribehenate, or esters of tricarboxylic acids and aliphatic monoalcohols.
esters of tetrahydric alcohols and aliphatic monocarboxylic acids, such as pentaerythritol tetrastearate and pentaerythritol tetrapalmitate, or esters of tetracarboxylic acids and aliphatic monoalcohols;
esters of hexahydric alcohols and aliphatic monocarboxylic acids, such as dipentaerythritol hexastearate and dipentaerythritol hexapalmitate, or esters of hexacarboxylic acids and aliphatic monoalcohols;
esters of polyhydric alcohols and aliphatic monocarboxylic acids, such as polyglycerol behenate, or esters of polycarboxylic acids and aliphatic monoalcohols; and
natural ester waxes such as carnauba wax and rice wax; (these are also simply referred to as ester wax)
ketone waxes such as dibehenyl ketone, diheptadecyl ketone (stearone), distearyl ketone, dieicosyl ketone, dipalmityl ketone, dimyristyl ketone, dilauryl ketone, diheptadecyl ketone, lauryl myristyl ketone, lauryl palmityl ketone, myristyl palmityl ketone, myristyl stearyl ketone, myristyl behenyl ketone, palmityl stearyl ketone, palmityl behenyl ketone, and stearyl behenyl ketone;
higher aliphatic alcohols;
fatty acids such as stearic acid, palmitic acid, and the like;
amide waxes; and
low molecular weight crystalline polyesters such as diethylene glycol distearate.

Other than those exemplified above, in the case where the hydrophobic property of the surface treating agent is extremely high (small HSP2), any one of the following may be used:
petroleum-based waxes such as paraffin wax, microcrystalline wax, and petrolatum, and derivatives thereof;
hydrocarbon-based waxes by the Fischer-Tropsch method and derivatives thereof;
polyolefin waxes such as polyethylene wax and polypropylene wax, and derivatives thereof (these are also simply referred to as hydrocarbon waxes).

Among these waxes, paraffin wax, ketone wax, and ester wax are preferable, ketone wax and ester wax are more preferable, ester wax is still more preferable, and ester wax having two or more ester groups is most preferable.

The melting point of the wax is preferably 65° C. to 90° C. from the viewpoint of low-temperature fixability and heat-resistant storage property. The melting point is a value measured using a differential scanning calorimeter (e.g., “Diamond DSC” manufactured by PerkinElmer, Inc.). To be specific, 3.0 mg of the wax is sealed in an aluminum pan, and the aluminum pan is set in a holder. An empty aluminum pan is used as a reference. The measurement conditions are a measurement temperature of 0° C. to 100° C. and a temperature increase rate of 10° C./min, and the melting point can be obtained from data during the temperature increase.

The content mass of the wax is preferably 7% by mass to 15% by mass and more preferably 7.5% by mass to 10% by mass based on the total mass of the toner base particles. When the content proportion of the wax is within the above range, fixability and separability in a fixing step and heat-resistant storage property of the toner are easily enhanced.

### 1-2-2. Binder Resin

The binder resin includes a crystalline polyester resin and an amorphous resin.

### 1-2-2-1. Amorphous Resin

Examples of the amorphous resin include a styrene resin, an acrylic resin, a styrene/acrylic copolymer resin, an olefin resin, an amorphous polyester resin, a polyamide-based resin, a polycarbonate resin, a polyether resin, a polyvinyl acetate resin, a polysulfone resin, an epoxy resin, a urethane resin, and a urea resin. These may be used alone or in combination of two or more types thereof. Preferred are resins selected from the group consisting of styrene resin, acrylic resin, styrene/acrylic copolymer resin, and amorphous polyester resin, from the viewpoint of improving the low-temperature fixability, the heat-resistant storage property of the toner, and heat resistance of the fixed image.

### 1-2-2-1-1. Styrene Resin, Acrylic Resin, Styrene/Acrylic Copolymer Resin

As monomers forming the styrene resin, the acrylic resin, and the styrene/acrylic copolymer resin, the following monomers may be used.

Examples of the monomer include the following:
styrene monomers such as styrene, o-methylstyrene, m-methylstyrene, p-methylstyrene, α-methylstyrene, p-phenylstyrene, p-ethylstyrene, 2,4-dimethylstyrene, p-tert-butylstyrene, p-n-hexylstyrene, p-n-octylstyrene, p-n-nonylstyrene, p-n-decylstyrene, p-n-dodecylstyrene and derivatives thereof;
(meth)acrylic acid ester monomers such as methyl (meth)acrylate, ethyl (meth)acrylate, n-butyl (meth)acrylate, isopropyl (meth)acrylate, isobutyl (meth)acrylate, t-butyl (meth)acrylate, n-octyl (meth)acrylate, 2-ethylhexyl (meth)acrylate, stearyl (meth)acrylate, lauryl (meth)acrylate, phenyl (meth)acrylate, diethylaminoethyl (meth)acrylate, dimethylaminoethyl (meth)acrylate, and derivatives thereof;
vinyl esters such as vinyl propionate, vinyl acetate, and vinyl benzoate;
vinyl ethers such as vinyl methyl ether and vinyl ethyl ether;
vinyl ketones such as vinyl methyl ketone, vinyl ethyl ketone, and vinyl hexyl ketone;
n-vinyl compounds such as vinylcarbazole, N-vinylindole and N-vinylpyrrolidone;
vinyl compounds such as vinylnaphthalene and vinylpyridine;
(meth)acrylic acid derivatives such as acrylonitrile, methacrylonitrile, and acrylamide; and the like.

In addition, as the monomer, a monomer having an ionically dissociable group such as a carboxy group, a sulfonic acid group, or a phosphate group is preferably used.

Examples of monomers having ionically dissociable groups include the following:
monomers having a carboxy group, such as (meth)acrylic acid, maleic acid, itaconic acid, cinnamic acid, fumaric acid, monoalkyl maleate, and monoalkyl itaconate;
monomers having a sulfonic acid group, such as styrene sulfonic acid, allylsulfosuccinic acid, and 2-acrylamido-2-methylpropanesulfonic acid;
monomers having a phosphate group such as acid phosphoxyethyl methacrylate; and the like.

As the monomer, a polyfunctional monomer may be used, and a crosslinked structure may be formed. Examples of the polyfunctional monomer include divinylbenzene, ethylene glycol di(meth)acrylate, diethylene glycol di(meth)acrylate, triethylene glycol di(meth)acrylate, and neopentyl glycol di(meth)acrylate.

As the monomer, only one of these may be used, or two or more thereof may be used in combination.

### 1-2-2-1-2. Amorphous Polyester Resin

The amorphous polyester resin refers to a polyester resin which does not show a clear endothermic peak in differential scanning calorimetry (DSC) among known polyester resins obtained by a polycondensation reaction of a divalent or higher carboxylic acid carboxylic acid and a divalent or higher alcohol (polyhydric alcohol). Here, the clear endothermic peak specifically means a peak having a half value width of the endothermic peak of 15° C. or less when measured at a temperature increase rate of 10° C./min in differential scanning calorimetry (DSC).

The polycarboxylic acid is a compound having two or more carboxy groups in one molecule.

Examples of polycarboxylic acid for forming the amorphous polyester resin include the following:
saturated aliphatic dicarboxylic acids such as oxalic acid, malonic acid, succinic acid, glutaric acid, adipic acid, pimelic acid, suberic acid, azelaic acid, sebacic acid, 1,9-nonanedicarboxylic acid, 1,10-decanedicarboxylic acid, 1,11-undecanedicarboxylic acid, 1,12-dodecanedicarboxylic acid, 1,13-tridecanedicarboxylic acid, 1,14-tetradecanedicarboxylic acid, 1,16-hexadecanedicarboxylic acid, and 1,18-octadecanedicarboxylic acid;
aromatic dicarboxylic acids such as phthalic acid, isophthalic acid, terephthalic acid, and naphthalenedicarboxylic acid;
unsaturated aliphatic dicarboxylic acids such as maleic acid, fumaric acid, itaconic acid, citraconic acid, glutaconic acid, isododecenylsuccinic acid, n-dodecenylsuccinic acid, and n-octenylsuccinic acid;
polycarboxylic acids having three or more valences such as trimellitic acid, pyromellitic acid, naphthalenetricarboxylic acid, naphthalenetetracarboxylic acid, pyrenetricarboxylic acid, and pyrenetetracarboxylic acid; and the like.

These may be used alone or in combination of two or more types thereof.

The polyhydric alcohol is a compound containing two or more hydroxyl groups in one molecule.

Examples of the polyhydric alcohol for forming the amorphous polyester resin include the following:
aliphatic diols such as ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,20-eicosanediol;
bisphenols such as bisphenol A and bisphenol F, and alkylene oxide adducts of bisphenols such as ethylene oxide adducts and propylene oxide adducts thereof;
polyols having 3 or more hydroxyl groups such as glycerin, pentaerythritol, hexamethylolmelamine, hexaethylolmelamine, tetramethylolbenzoguanamine, and tetraethylolbenzoguanamine; and the like.

These may be used alone or in combination of two or more types thereof.

### 1-2-2-1-3. Characteristics of Amorphous Resin

The glass transition point of the amorphous resin is preferably 30° C. to 50° C. When the glass transition point of the amorphous resin falls within the above range, the balance between low-temperature fixability and heat-resistant storage property becomes satisfactory. The glass transition point is a value measured using differential scanning calorimetry (e.g., “Diamond DSC” manufactured by PerkinElmer, Inc). To be specific, 3.0 mg of the measurement sample sealed in an aluminum pan is set in a holder. An empty aluminum pan is used as a reference. The measurement conditions are a measurement temperature of 0° C. to 100° C. and a temperature increase rate of 10° C./min, and the analysis is performed based on the data during the temperature increase. An extended line of the base line before the rising of the first endothermic peak and a tangent line showing the maximum inclination between the rising portion of the first peak and the peak apex are drawn, and the intersection point thereof can be used as the glass transition point.

The weight-average molecular weight of the amorphous resin is preferably 10,000 to 50000, and more preferably 25000 to 35000. Furthermore, from the same viewpoint, the number-average molecular weight is preferably 5000 to 20000, and more preferably 6500 to 12000. When the weight-average molecular weight or the number-average molecular weight is equal to or greater than the lower limit value, fixability and separability are easily enhanced. When the weight-average molecular weight or the number-average molecular weight is equal to or less than the upper limit value, low-temperature fixability is easily enhanced. The weight-average molecular weight and the number-average molecular weight are values measured by gel permeation chromatography (GPC).

To be specific, an apparatus “HLC-8120GPC” (manufactured by Tosoh Corporation) and a column “TSK guard column+TSKgel SuperHZ-M3 series” (manufactured by Tosoh Corporation) are used. The measurement conditions were a column temperature of 40° C., a carrier-solvent of tetrahydrofuran (THF), and a carrier-solvent flow rate of 0.2 ml/min. A measurement sample (amorphous resin) is dissolved in tetrahydrofuran so as to have a concentration of 1 mg/ml under dissolution conditions in which the sample is treated for 5 minutes using an ultrasonic disperser at room temperature. A tetrahydrofuran solution of a measurement sample is treated with a membrane filter having a pore size of 0.2 μm. This sample solution (10 μL) is injected into the device together with the above-described carrier solvent, and the detection is performed using a refractive index detector (RI detector). The weight-average molecular weight and the number-average molecular weight of the measurement sample can be calculated as polystyrene equivalent values using a calibration curve created using 10 samples of monodispersed polystyrene standard particles.

The content ratio of the amorphous resin is preferably 80% by mass to 95% by mass based on the total mass of the binder resin. When the content proportion of the amorphous resin is within the above range, the fixability is easily enhanced, and the heat-resistant storage property of the toner and the heat resistance of the fixed image are easily enhanced.

### 1-2-2-2. Crystalline Polyester Resin

The crystalline polyester resin refers to a resin having not a stepwise endothermic change but a clear melting peak in differential scanning calorimetry (DSC) among known polyester resins obtained by a polycondensation reaction of a polycarboxylic acid and an alcohol having 2 or more hydroxyl groups (polyhydric alcohol). Here, the clear endothermic peak specifically means a peak having a half value width of the endothermic peak of 15° C. or less when measured at a temperature increase rate of 10° C./min in differential scanning calorimetry (DSC).

Examples of the polycarboxylic acid for forming the crystalline polyester resin include the following:
saturated aliphatic dicarboxylic acids such as succinic acid;
cycloaliphatic dicarboxylic acids such as cyclohexanedicarboxylic acid;
aromatic dicarboxylic acids such as phthalic acid, isophthalic acid, terephthalic acid;
polycarboxylic acid having 3 or more valences such as trimellitic acid and pyromellitic acid;
anhydrides or alkyl esters having 1 to 3 carbon atoms of these carboxylic acid compounds; and the like.

These may be used alone or in combination of two or more types thereof.

Examples of polyhydric alcohols for forming the crystalline polyester resin include the following:
aliphatic diols such as 1,2-propanediol, 1,3-propanediol, 1,4-butanediol, 1,5-pentanediol, 1,6-hexanediol, 1,7-heptanediol, 1,8-octanediol, neopentyl glycol, and 1,4-butenediol;
polyhydric alcohols having 3 or more hydroxyl groups, such as glycerol, pentaerythritol, trimethylolpropane and sorbitol; and the like. These may be used alone or in combination of two or more types thereof.

The content of the crystalline polyester is preferably 5% by mass to 20% by mass based on the total mass of the binder resin. When the content is 5% by mass or more, the low-temperature fixability is easily enhanced. When the content is 20% by mass or less, uneven distribution of the crystalline polyester in the toner base particle is prevented, the toner base particle is more likely to be uniformly melted in the fixing step, and the effect of preventing gloss unevenness by the wax or the like is more likely to be enhanced. In addition, the crystalline polyester is more likely to be contained in the toner base particle during toner production, and exposure of the crystalline polyester to the surface of the toner base particle is more likely to be reduced. Usually, the crystalline polyester in the toner base particle has a crystalline component and an amorphous component, and the amorphous component has a relatively low glass transition temperature. As a result, when the exposure of the crystalline polyester to the surface of the toner base particle is reduced, the exposure of the amorphous component having a relatively low glass transition temperature is also reduced. Therefore, the fusion between the toner particles during storage is reduced, and the heat-resistant storage property of the toner is easily enhanced. From the viewpoint of easily enhancing the low-temperature fixability, the content of the crystalline polyester is more preferably 7.5% by mass to 20% by mass, and even more preferably 12.5% by mass to 20% by mass, based on the total mass of the binder resin. In addition, from the viewpoint of easily preventing gloss unevenness, the content of the crystalline polyester is more preferably 5% by mass to 17.5% by mass and even more preferably 5% by mass to 12.5% by mass based on the total mass of the binder resin.

The crystalline polyester preferably has a melting point of about 65° C. to 90° C. from the viewpoints of low-temperature fixability and heat-resistant storage property. The melting point of the crystalline polyester resin is a value measured as follows. The melting temperature of a crystalline polyester indicates a temperature of a maximum of a melting peak, and is measured by differential scanning calorimetry using “DSC7000X” (manufactured by Hitachi-hightech, Ltd). For example, 1.0 mg of a measurement sample (crystalline polyester) is sealed in an aluminum pan (KITNO. B0143013), which is set in a sample holder of “DSC7000X”, and measurement is carried out at a measurement temperature of 0 to 100° C. at a temperature increase rate of 10° C./min. The melting temperature can be obtained from the analysis of the heating curve.

The weight-average molecular weight of the crystalline polyester is preferably 5000 to 30000 from the viewpoint of easily improving low-temperature fixability and heat-resistant storage property. The weight-average molecular weight of the crystalline polyester resin can be measured in the same manner as in the weight-average molecular weight of the amorphous resin.

### 1-2-4. Coloring Agent

As the coloring agent, various known coloring agents such as carbon black, black iron oxide, dyes, and pigments can be used.

Examples of the carbon black include channel black, furnace black, acetylene black, thermal black, and lamp black. Examples of the black iron oxide include magnetite, hematite, and titanium trioxide iron. Examples of the dyes include C. I. Solvent Red 1, 49, 52, 58, 63, 111, and 122, C. I. Solvent Yellow 19, 44, 77, 79, 81, 82, 93, 98, 103, 104, 112, and 162, and C. I. Solvent Blue 25, 36, 60, 70, 93, and 95. Examples of pigments include C. I. Pigment Red 5, 48:1, 48:3, 53:1, 57:1, 81:4, 122, 139, 144, 149, 150, 166, 177, 178, 222, 238, 269, c. I. Pigment Orange 31, 43, C. I. Pigment Yellow 14, 17, 74, 93, 94, 138, 155, 156, 158, 180, 185, C. I. Pigment Green 7, and C. I. Pigment Blue 15:3, 60 and the like. The coloring agents for obtaining the toners of the respective colors may be used alone or in combination of two or more for the respective colors.

The content of the coloring agent is preferably 1% by mass to 10% by mass, and more preferably 2% by mass to 8% by mass, based on the total mass of the toner base particles. When the content of the coloring agent is 1% by mass or more, the color developability is more likely to be enhanced, and sufficient color developability is more likely to be obtained. When the amount of the coloring agent is 10% by mass or less, the coloring agent is less likely to be free from the toner base particle, adhesion of the coloring agent to a carrier or the like is more likely to be prevented, and the chargeability is more likely to be enhanced.

### 1-2-5. Characteristics of Toner Base Particle

The average particle diameter of the toner base particle is preferably from 3 μm to 10 μm, and more preferably from 5 μm to 8 μm, in terms of volume-based median diameter. This average particle diameter can be controlled by the concentration of the aggregating agent and the amount of the organic solvent to be added, which are used in the production, the fusion time, the composition of the binder resin, and the like. When the volume-based median diameter is within the above range, for example, an extremely minute dot image at a 1200 dpi level is more likely to be faithfully reproduced. The volume-based median diameter of the toner is a value measured and calculated by using a measurement apparatus in which a computer system equipped with data-processing software “Software V3.51” is connected to “Multisizer 3” manufactured by Beckman Coulter, Inc. To be specific, 0.02 g of the measurement sample is added to and blended with 20 mL of a surfactant (for example, a surfactant solution obtained by diluting a neutral detergent containing a surfactant ingredient with pure water by a factor of 10 for the purpose of dispersing toner base particles), and then ultrasound dispersion is performed for 1 minute to prepare a toner dispersion liquid. The toner dispersion liquid is pipetted into a beaker containing “ISOTONII” (manufactured by Beckman Coulter, Inc.) in a sample stand until a display concentration of a measurement apparatus becomes 8%. Here, by setting the concentration in this range, a reproducible measurement value is easily obtained. The measurement conditions are as follows: the number of counted particles is 25000 and the aperture diameter is 100 μm. The range of 2 μm to 60 μm, namely a measurement range, is divided into 256 parts to calculate frequency values, and the particle size of the largest 50% of the volume cumulative fraction can be taken as the volume-based median diameter.

The average circularity of the toner base particles is preferably 0.930 to 1.000, and more preferably 0.950 to 0.995, from the viewpoint that stability of charging characteristics and low-temperature fixability are more likely to be enhanced. When the average circularity is within the above range, individual toner base particles are less likely to be crushed, contamination of a charging member is reduced, and the chargeability of the toner tends to become stable. In addition, the image quality is easily improved. The average circularity of the toner is a value measured using “FPIA-3000” manufactured by Sysmex Corporation. Specifically, the measurement sample is wetted with an aqueous solution containing a surfactant, subjected to ultrasound dispersion treatment for 1 minute for dispersion, and then an image is captured using “FPIA-3000” manufactured by Sysmex Corporation under measurement conditions of an HPF (high-power field imaging) mode at an appropriate density with an HPF detection number of 3000 to 10000. The average circularity is a value calculated by calculating the circularity of individual toner base particles according to the following expression (y), adding the circularities of the respective toner base particles, and dividing the sum by the total number of toner base particles. When the number of HPF detections is within the above range, reproducibility is easily obtained.

$$Circularity = ( Perimeter of circle having the same projected area as particle image ) / ( Perimeter of particle projection image ) \qquad Expression ( y )$$

The toner base particle preferably has a core-shell structure, from the viewpoint that low-temperature fixability and heat-resistant storage property are more likely to be enhanced. Note that the shell layer is not limited to a layer completely covering the core particle, and the surface of the core particle may be partially exposed.

The component constituting the shell layer is not particularly limited, but an amorphous resin such as an amorphous polyester resin, a styrene resin, an acrylic resin, and a styrene/acrylic copolymer resin are preferable. The content of the resin forming the shell layers is preferably 5% by mass to 30% by mass based on the total mass of the toner base particles.

### 1-3. Others

The bulk density of the toner is preferably 0.350 g/cm³ or more, more preferably 0.370 g/cm³ or more, and still more preferably 0.390 g/cm³ or more. The upper limit value is, for example, preferably 0.450 g/cm³ or less. The bulk density is a physical property value indicating the fluidity and packing effect of the toner, and when the bulk density is 0.350 g/cm³ or more, the packing effect is easily reduced and the fluidity is easily enhanced. In addition, when the bulk density is 0.450 g/cm³ or less, the handling performance of the toner during supply of the toner is readily enhanced.

The bulk density of the toner can be determined in the same manner as in the method described in Japanese Unexamined Patent Publication No. 2014-137518. In particular, as shown in FIG. 1 of Japanese Unexamined Patent Publication No. 2014-137518, a cylindrical container with a capacity of 25 cm³ having a circular opening with a 28 mm diameter at the upper end is placed on a container base placed on a horizontal plane. By a funnel holding portion of a stand provided on the container base, a funnel including a discharge port with a caliber of 2.5 mm at a lower end is held at a position where a distance from an opening of the container to a tip of the discharge port of the funnel is 25 mm, directly above the cylindrical container. Next, the measurement target toner is discharged and dropped from a discharge port of the funnel and is poured into a cylindrical container from an opening thereof until the toner overflows from the opening of the container. After the raised sample portion is removed by leveling the toner horizontally along the surface of the opening of the container, the mass of the toner filling the container is measured. From the measurement value, the bulk density d (g/cm³) of the toner is determined by the following expression (B).

$$d = ( mass ( g ) ) of sample in container ) / ( volume of container ( {cm}^{3} ) ) \qquad Expression ( B )$$

The 50% aggregation temperature of the toner is preferably 57.5° C. or higher, more preferably 60.0° C. or higher, and still more preferably 62.0° C. or higher. The upper limit value can be, for example, 65.0° C. or less. When the 50% aggregation temperature is 57.5° C. or more, the heat-resistant storage property is more likely to be enhanced.

The 50% aggregation temperature of the toner is, for example, a value determined by the following method. Toner 0.5 g is placed in a 10 ml glass bottle with a 21 mm inner diameter, the lid is closed, and the glass bottle is shaken with “Tap Denser KYT-2000” (manufactured by Seishin Enterprise Co., Ltd.) at room temperature for 600 times. The bottles are left in an environment of three levels of temperatures of 57.5° C., 60.0° C. and 62.5° C. and 35% RH for 2 hours in a state where the lids are removed. Next, the toner was placed on a 48-mesh (opening: 350 μm) sieve with care not to crush toner aggregates, set in a powder tester (manufactured by Hosokawa Micron Corporation), fixed with a press bar and a knob nut, adjusted to a vibration strength of 1 mm feed, and vibrated for 10 seconds. Thereafter, the ratio (% by mass) of the amount of the toner remaining on the sieve is measured, and the toner aggregation rate is calculated based on the following formula.

$$Toner aggregation rate ( \% ) = Weight ( g ) of residual toner on sieve / 0.5 ( g ) \times 100$$

The toner aggregation rate is measured at the three levels of temperature, the temperature at which the aggregation rate reaches 50% is estimated, and this temperature is taken as the 50% aggregation temperature.

The minimum fixing temperature (U.O. avoidance temperature) of the toner is preferably lower than 140° C., more preferably lower than 135° C., and even more preferably lower than 130° C. As the minimum fixing temperature is lower, the low-temperature fixability is more likely to be enhanced.

The minimum fixing temperature in the present application is, for example, a value obtained by the following method. A fixing apparatus of “bizhub PRESS (registered trademark) C1070” manufactured by Konica Minolta Inc., which is a multi-functional peripheral, modified so that surface temperature of an upper fixing belt and a lower fixing roller can be changed is prepared. The above apparatus is modified so that the fixing temperature, the amount of toner adhesion, and the system speed can be set at any values. Under an environment of normal temperature and humidity (temperature: 20° C., relative humidity: 50% RH), the adhesion amount is set to 11.3 g/m² on A4 size high-quality paper “NPI High-Quality (127.9 g/m²)” manufactured by Nippon Paper Industries Co., Ltd. Thereafter, a fixing experiment for fixing an image of a 100 mm×100 mm size is repeatedly performed up to 180° C. while changing the set fixing temperature from 120° C. in increments of 1° C. The minimum fixing temperature at which image contamination due to fixing offset is not visually confirmed is defined as the minimum fixing temperature (U.O. avoidance temperature).

The toner according to the present embodiment may be used as a magnetic or non-magnetic mono-component developer, or may be mixed with a carrier and used as a two-component developer.

When the toner is used as a two-component developer, magnetic particles formed of a conventionally known material, for example, a metal such as iron, ferrite, or magnetic, or an alloy of any of these metals and a metal such as aluminum or lead, can be used as a carrier. Among these, ferrite particles are particularly preferable. In addition, as the carrier, a coated carrier in which the surface of magnetic particles is coated with a coating agent such as a resin, a dispersion-type carrier in which a magnetic fine powder is dispersed in a binder resin, or the like may be used.

The volume-based median diameter of the carrier is preferably from 20 μm to 100 μm, and more preferably from 25 μm to 80 μm. The volume median diameter of the carrier is a value measured with a laser diffraction particle size distribution analyzer (for example, “HELOS” manufactured by Sympatec GmbH) equipped with a wet disperser.

### 2. Method for Producing Toner

A method for producing the toner according to the present embodiment is not particularly limited, and a known method can be used. Examples of the production method include a pulverization method, an emulsion dispersion method, a suspension polymerization method, a dispersion polymerization method, an emulsion polymerization method, and an emulsion polymerization aggregation method. Among these, the emulsion polymerization aggregation method is preferable from the viewpoints of production cost and production stability.

In the method for producing a toner by the emulsion polymerization aggregation method, an aqueous dispersion liquids containing fine particles of the respective components in aqueous media are prepared, the respective aqueous dispersion liquids are mixed, and the fine particles of the respective components are aggregated and thermally fused, so that toner base particles can be formed.

The binder resin fine particles may have a multilayer structure of two or more layers in which binder resins having different compositions are contained in the respective layers, and can be formed by performing a polymerization reaction in multiple stages. For example, binder resin fine particles having a two layer structure can be produced by a method in which a dispersion liquid of resin fine particles is prepared by first stage polymerization, a polymerization initiator and a polymerizable monomer are added to the dispersion liquid, and second stage polymerization is performed.

Here, the aqueous dispersion liquid refers to a liquid in which dispersions (particles) are dispersed in an aqueous medium, and the aqueous medium refers to a medium in which the content of water is 50% by mass or more based on the total mass of the solvent. Examples of the components other than water include organic solvents that dissolve in water. Examples of the organic solvent soluble in water include methanol, ethanol, isopropanol, butanol, acetone, methyl ethyl ketone, and tetrahydrofuran. Among these, an alcohol-based organic solvent such as methanol, ethanol, isopropanol, or butanol, which is an organic solvent that does not dissolve a resin, is preferably used.

An example of the production method by the emulsion polymerization aggregation method is a production method including the following steps:
(a) preparing an aqueous dispersion liquid containing fine particles of a binder resin (hereinafter may also referred to as “binder resin fine particles”) in an aqueous medium;
(b) preparing an aqueous dispersion liquid containing colorant fine particles in an aqueous medium;
(c) aggregating and fusing binder resin fine particles and colorant fine particles in an aqueous medium to form associated particles;
(d) aging the associated particles with thermal energy to control the shape and obtain toner base particles;
(e) cooling the dispersion liquid of the toner base particles;
(f) a crystallization promoting step in which the cooled dispersion liquid of the toner base particles is reheated to promote crystallization;
(g) filtering the toner base particles from the aqueous medium to remove the surfactant and the like from the toner base particle;
(h) drying the washed toner base particles; and
(I) adding an external additive to the dried toner base particles.

All of the steps (a) to (i) above may be performed, or only some of the steps may be performed.

### (a) Step of Preparing Aqueous Dispersion Liquid of Binder Resin Fine Particles

In this step, an aqueous dispersion liquid containing fine particles of a binder resin is prepared.

In a case where the binder resin is a resin synthesized by radical polymerization (e.g., a styrene resin, an acrylic resin, a styrene/acrylic copolymer resin, or the like), the aqueous dispersion liquid of binder resin fine particles can be prepared by a mini-emulsion polymerization method using the monomers exemplified above. Any monomer exemplified above is added to an aqueous medium containing a surfactant, mechanical energy is applied to form droplets, and then a polymerization reaction is caused to proceed in the droplets by radicals from a water-soluble radical polymerization initiator. Note that an oil-soluble polymerization initiator may be contained in the droplets.

### [Surfactant]

As the surfactant used in this step, any one of various conventionally known anionic surfactants, cationic surfactants, nonionic surfactants, and the like can be used.

### [Polymerization Initiator]

As the polymerization initiator used in this step, a known initiator can be used. Examples of the polymerization initiator for use include persulfates (potassium persulfate, ammonium persulfate, and the like), azo-based compounds (4,4′-azobis-4-cyanovaleric acid and salts thereof, 2,2′-azobis(2-amidinopropane) salts, and the like), peroxide compounds, azobisisobutyronitrile, and the like. Among these, persulfates (potassium persulfate, ammonium persulfate, and the like) are preferable.

### [Chain Transfer Agent]

In this step, a known chain transfer agent can be used for the purpose of adjusting the molecular weight of the binder resin. Examples of the chain transfer agent include 2-chloroethanol, mercaptans such as octyl mercaptan, dodecyl mercaptan, and t-dodecyl mercaptan, and styrene dimers.

In the case where the binder resin is a resin synthesized by condensation polymerization (e.g., a crystalline polyester resin or an amorphous polyester resin), the aqueous dispersion liquid of binder resin fine particles can be prepared by synthesizing the binder resin and dispersing the binder resin in the form of fine particles in an aqueous medium. Specifically, an oil phase liquid is prepared by dissolving or dispersing a binder resin in an organic solvent. The oil phase liquid is dispersed in an aqueous medium by phase inversion emulsification or the like to form oil droplets controlled to have a desired particle diameter. Thereafter, the organic solvent can be removed to prepare an aqueous dispersion liquid of binder resin fine particles.

The amount of the aqueous medium used is preferably 50 parts by mass to 2000 parts by mass, and more preferably 100 parts by mass to 1000 parts by mass, relative to 100 parts by mass of the oil phase liquid.

A surfactant or the like may be added to the aqueous medium for the purpose of improving the dispersion stability of the oil droplets. Examples of the surfactant include the same surfactants as those exemplified in the above-described step.

As the organic solvent used in the preparation of the oil phase liquid, organic solvents having a low boiling point and low solubility in water are preferable from the viewpoint that removal treatment after the formation of oil droplets is easy. Examples of such an organic solvent include methyl acetate, ethyl acetate, methyl ethyl ketone, methyl isobutyl ketone, toluene, and xylene. These may be used alone or in combination of two or more types thereof. The amount of the organic solvent used can be 1 parts by mass to 300 parts by mass relative to 100 parts by mass of the binder resin.

The emulsification and dispersion of the oil phase liquid can be performed using mechanical energy.

The toner base particle according to the present embodiment contains a wax. In this step, the wax may be dissolved or dispersed in advance in a monomer solution for synthesizing a binder resin to be formed by radical polymerization or in an oil phase liquid of a binder resin to be formed by condensation polymerization. Thus, the wax can be introduced into the toner base particle. Alternatively, the wax can be introduced into the toner base particle by preparing a dispersion liquid of wax fine particles containing the wax and aggregating the wax fine particles together with the binder resin fine particles and the colorant fine particles in the aggregation and fusion step. Among these, it is preferable to dissolve or disperse the wax in a monomer solution or an oil phase liquid in advance.

The toner base particle according to the present embodiment may additionally contain an internal additive such as a charge control agent, when necessary. Such an internal additive may be dissolved or dispersed in advance in, for example, a monomer solution for synthesizing a binder resin to be formed by radical polymerization or in an oil phase liquid of a binder resin to be formed by condensation polymerization in this step. Alternatively, the internal additive can be introduced into the toner base particle by separately preparing a dispersion liquid of internal additive fine particles containing the internal additive, and aggregating the internal additive fine particles together with binder resin fine particles and colorant fine particles in the aggregation and fusion step. Among these, it is preferable to dissolve or disperse the internal additive in a monomer solution or an oil phase liquid in advance.

The average particle diameter of the binder resin fine particles is preferably in the range of 100 nm to 400 nm in volume-based median diameter. The volume median diameter of the binder resin fine particles is a value measured using “Microtrac UPA-150” manufactured by Nikkiso Co., Ltd.

The binder resin includes at least two resins, namely the crystalline polyester resin and the amorphous resin. In such a case, one type of fine particles containing a plurality of resins may be prepared, a plurality of fine particles containing only one type of resin may be prepared, or fine particles containing a plurality of resins and fine particles containing only one type of resin may be prepared.

### (b) Step of Preparing Aqueous Dispersion Liquid of Colorant Fine Particles

This step is an optional step carried out as necessary when toner base particles containing a coloring agent are desired, and is a step of dispersing the coloring agent in the form of fine particles in an aqueous medium to prepare an aqueous dispersion liquid of colorant fine particles.

The aqueous dispersion liquid of the colorant fine particles can be obtained by dispersing a coloring agent in an aqueous medium to which a surfactant is added at a critical micelle concentration (CMC) or more.

The coloring agent can be dispersed by utilizing mechanical energy. As the disperser, a known disperser can be used, and examples thereof include ultrasound dispersers, mechanical homogenizers, pressure dispersers such as Manton-Gaulin homogenizer and pressure type homogenizer, media type dispersers such as sand grinder, Getzman mill and diamond fine mill, and the like.

The volume-based median diameter of the colorant fine particles in a dispersed state is preferably 10 nm to 300 nm, more preferably 100 nm to 200 nm, and still more preferably 100 nm to 150 nm. The volume-based median diameter of the colorant fine particles is a value measured, for example, with “NANOTRAC Wave II” (manufactured by Microtrac), which is a particle size measurement apparatus using a dynamic light scattering method.

### (c) Aggregation and Fusion Step

In this step, the binder resin fine particles, the colorant fine particles, and, when necessary, fine particles of other toner constituent components are aggregated and further fused by heating.

Specifically, an aggregating agent in an amount equal to or more than the critical aggregation concentration is added to an aqueous dispersion liquid in which the fine particles are dispersed in an aqueous medium, and the mixture is heated to a temperature equal to or more than the glass transition point of the amorphous resin to aggregation and fuse the fine particles.

The fusion temperature for fusing the binder resin fine particles and the like may be equal to or higher than the glass transition point of the binder resin, but is preferably from (glass transition point of binder resin+10° C.) to (glass transition point of binder resin+50° C.), and particularly preferably from (glass transition point of binder resin+15° C.) to (glass transition point of binder resin+40° C.).

### [Aggregating Agent]

The aggregating agent used in this step is not particularly limited, but an agent selected from metal salts such as alkali metal salts and alkaline earth metal salts is suitably used. Examples of the metal salt include salts of monovalent metals such as sodium, potassium, and lithium; salts of divalent metals such as calcium, magnesium, manganese, and copper; and salts of trivalent metals such as iron and aluminum. Specific examples of the metal salt include sodium chloride, potassium chloride, lithium chloride, calcium chloride, magnesium chloride, zinc chloride, copper sulfate, magnesium sulfate, manganese sulfate and the like. Among these, a divalent metal salt is preferably used because aggregation can be advanced with a smaller amount thereof. These may be used alone or in combination of two or more types thereof.

When the toner base particles have a core-shell structure, the toner base particles can be produced, for example, by the following step. The binder resin fine particles and the colorant fine particles are aggregated and fused to form core particles. Thereafter, the resin fine particles for shell for forming the shell layer are aggregated and fused to the core particles, thereby forming toner base particles having a core-shell structure.

### (d) Aging Step

This step is performed as necessary, and in the aging step, an aging treatment is performed in which the toner base particles obtained in the aggregation and fusion step are aged by thermal energy until a desired shape is obtained to form the toner base particles.

Specifically, the aging treatment can be performed by adjusting the heating temperature, the stirring speed, the heating time, and the like until the shape of the associated particles has a desired circularity by heating and stirring the system in which the associated particles are dispersed.

### (e) Cooling Step

This step is a step of subjecting the dispersion liquid of the toner base particles to a cooling treatment. As the conditions of the cooling treatment, it is preferable to perform cooling at a cooling rate of 1° C./min to 20° C./min. Examples of the cooling treatment method include a method of cooling by introducing a refrigerant from the outside of the reaction vessel, a method of cooling by directly charging cold water into the reaction system and the like.

### (f) Heat Treatment Step

This step is a step of promoting crystallization of the crystalline resin in the toner base particles. As conditions for the heat treatment, heating is preferably performed for 30 minutes or more within a range from a glass transition temperature of the binder resin or higher to a temperature lower than the melting point of the crystalline resin by 5° C.

### (g) Filtration and Washing Step

This step is a step of subjecting the toner base particle to solid-liquid separation from the cooled dispersion liquid of the toner base particles, removing adhering substances such as the surfactant and the aggregating agent from a toner cake (an aggregate in which the toner base particles in a wet state are aggregated in the form of a cake) obtained by the solid-liquid separation, and washing the toner cake.

The solid-liquid separation is not particularly limited, and a centrifugation method, a vacuum filtration method performed using a Nutsche or the like, a filter method performed using a filter press or the like, and the like can be used. Furthermore, in the washing, it is preferable to perform washing with water until the electrical conductivity of the filtrate becomes 10 μS/cm.

### (h) Drying Process

This step is a step of drying the washed toner cake, and can be performed in the same manner as in the drying step in a known method for producing toner base particle.

Examples of the dryer used for drying the toner cake include a spray dryer, a vacuum freeze dryer, and a reduced pressure dryer. A stationary shelf dryer, a movable shelf dryer, a fluidized bed dryer, a rotary dryer, or a stirring dryer is preferably used.

The dried toner base particle have a water content of preferably 5% by mass or less, and more preferably 2% by mass or less. Note that when the dried toner base particles are aggregation by a weak interparticle attractive force, the aggregation may be subjected to crushing treatment. As an example of a crushing treatment apparatus, a mechanical crushing apparatus such as a jet mill, a Henschel mixer, a coffee mill, or a food processor can be used.

### (I) Step of Adding External Additive

This is a step of adding an external additive to the toner base particle.

To the toner base particles, at least inorganic particles that have been surface-treated with a surface treating agent are externally added, and in order to improve the fluidity, chargeability, cleaning performance, or the like, for example, a fluidizing agent, a cleaning aid, or the like may also be added, but are not particularly limited.

The total amount of these external additives to be added is preferably 0.3 parts by mass to 3.0 parts by mass, and more preferably 1.0 parts by mass to 2.0 parts by mass, relative to 100 parts by mass of the toner base particles.

As a mixer for the external additive, a mechanical mixer such as a Henschel mixer or a coffee mill can be used.

Although the embodiment has been specifically described above, the present invention is not limited to the above-described example, and various modifications may be added.

### Examples

In the following, the present invention will be described with reference to examples. The scope of the present invention should not be construed as being limited to the examples.

### 1. Preparation of Materials

The following inorganic particles and surface treating agents were prepared.

### 1-1. Preparation of Inorganic Particles

AEROSIL40: Fumed silica having a particle diameter of 100 nm, product name “AEROSIL40 (registered trademark)” manufactured by Nippon Aerosil Co., Ltd.
AEROSIL50: fumed silica having a particle diameter of 30 nm, manufactured by Nippon Aerosil Co., Ltd., product name “AEROSIL50 (registered trademark)”
AEROSIL200: Fumed silica having a particle diameter of 12 nm: product name “AEROSIL200 (registered trademark)”, manufactured by Nippon Aerosil Co., Ltd.

The particle diameter is a value obtained by arithmetically averaging particle sizes of 1000 particles arbitrarily selected by observation with a transmission electron microscope (TEM).

### 1-2. Preparation of Surface Treating Agent

### [Reactive Silicone Oil]

DMO-SiOH1: reactive silicone oil (weight-average molecular weight of 7000) having hydroxyl groups at both ends of poly(dimethylsiloxane)
DMO-SiOH2: reactive silicone oil (weight-average molecular weight of 1200) having hydroxyl groups at both ends of poly(dimethylsiloxane)
DMO-SiOH3: reactive silicone oil (weight-average molecular weight of 19000) having hydroxyl groups at both ends of poly(dimethylsiloxane).

### [Non-Reactive Silicone Oil]

PDMS: poly (dimethylsiloxane), weight-average molecular weight of 7000
   [Surface Treating Agent Other than Silicone Oil]
HMDS: hexamethyldisilazane, molecular weight of 162
Octyltrimethoxysilane: molecular weight of 234

Each weight-average molecular weight of the reactive silicone oil and the non-reactive silicone oil is a value measured by gel permeation chromatography (GPC). To be specific, an apparatus “HLC-8120GPC” (manufactured by Tosoh Corporation) and a column “TSK guard column+TSKgel SuperHZ-M3 series” (manufactured by Tosoh Corporation) are used. The measurement conditions were a column temperature of 40° C., a carrier-solvent of tetrahydrofuran (THF), and a carrier-solvent flow rate of 0.2 ml/min. A measurement sample was dissolved in tetrahydrofuran so as to have a concentration of 1 mg/ml under dissolution conditions in which the sample was treated for 5 minutes using an ultrasonic disperser at room temperature. A tetrahydrofuran solution of a measurement sample was treated with a filter having a pore size of 0.2 μm. 10 μL of this sample solution was injected into the device along with the carrier solvent described above and the detection was performed using a refractive index detector (RI detector). A calibration curve prepared using 10 samples of monodispersed polystyrene standard particles was used to calculate the weight-average molecular weight of the measurement sample in terms of polystyrene.

### 2. Preparation of External Additive (Surface-Treated Inorganic Particles)

External additives 1 to 10 were prepared as described below. A list of the formulation, production method, and characteristics is given in Table 1.

### [Preparation of External Additive 1]

In a reactor, 100 parts by weight of AEROSIL50 was placed and while stirring under a nitrogen gas atmosphere, DMO-SiOH1 diluted with hexane was added in the ratio shown in Table 1, and surface treatment was carried out while stirring was continued. In order to break loose aggregation of the surface-treated silica, crushing was performed with a sample mill (manufactured by Nara Machinery Co., Ltd) as the final process. Thus, an external additive 1 was obtained.

### [Preparation of External Additive 2]

An external additive 2 was obtained in the same manner as in the external additive 1 except that the type of the surface treating agent was changed to PDMS, the amount of the surface treating agent added was changed to 3 parts by mass, the reaction temperature of the surface treatment was changed to 280° C., and the reaction time was changed to 30 minutes.

### [Preparation of External Additive 3]

An external additive 3 was obtained in the same manner as in the external additive 1 except that the reaction temperature of the surface treatment was changed to 340° C.

### [Preparation of External Additive 4]

External additive 4 was obtained in the same manner as external additive 1 except that the type of the surface treating agent was changed to DMO-SiOH2.

### [Preparation of External Additive 5]

External additive 5 was obtained in the same manner as external additive 1 except that the type of the surface treating agent was changed to DMO-SiOH3.

### [Preparation of External Additive 6]

External additive 6 was obtained in the same manner as external additive 1 except that the type of the inorganic particles was changed to AEROSIL40 and the amount of the surface treating agent added was changed to 5 parts by mass.

### [Preparation of External Additive 7]

External additive 7 was obtained in the same manner as external additive 1 except that the type of the inorganic particles was changed to AEROSIL200 and the amount of the surface treating agent added was changed to 10 parts by mass.

### [Preparation of External Additive 8]

External additive 8 was obtained in the same manner as external additive 1 except that the type of surface treating agent was changed to HMDS, the amount of the surface treating agent added was changed to 4 parts by mass, and the reaction time was changed to 100 minutes.

### [Preparation of External Additive 9]

External additive 9 was obtained in the same manner as external additive 1 except that the type of surface treating agent was changed to octyltrimethoxysilane, the amount of the surface treating agent added was changed to 4 parts by mass, and the reaction time was changed to 150 minutes.

### [Preparation of External Additive 10]

External additive 10 was obtained in the same manner as external additive 1 except that the amount of the surface treating agent added was changed to 2 parts by mass, the reaction temperature of the surface treatment was changed to 280° C., and the reaction time was changed to 20 minutes.

### [Calculation of HSP Value of Each External Additive (Additive Surface-Treated Inorganic Particles)]

The HSP value (HSP2) of the surface treating agent is a value calculated by the method of Hansen as follows. Hansen solubility parameters (δD, δP, δH) of each compound were calculated by inputting the chemical structures of the compounds to be calculated in the molecular linear notation Smiles equation using HSPiP (Ver. 6.0.04). From these values, the HSP value (HSP2) of each compound was calculated by calculating (δD²+δP²+δH²)^{0.5}.

### [Measurement of Hydrophobization Degree of Each External Additive (Surface-Treated Inorganic Particle)]

1.0 g of surface-treated inorganic particles was weighed and placed in a 200 mL separatory funnel, and 100 mL of pure water is added thereto, followed by shaking for 10 minutes in a turbulent mixer. After the shaking, the mixture was left to stand for 10 minutes, 20 to 30 mL of a liquid in the lower layer was removed from the funnel, and then the liquid in the lower layer was collected in a silica cell having an optical path length of 10 mm. Pure water was used as a blank for measurement with a colorimeter, and the transmittance of light with a wavelength of 500 nm was defined as the hydrophobization degree.

### [Measurement of Free Silicone Oil Content of Each External Additive (Surface-Treated Inorganic Particles)]

Using a Soxhlet extractor manufactured by Buchi Labortechnik GmbH, 0.5 g of the external additive was put into a 28 mm-diameter cylindrical filter paper, hexane was used as an extractant, and free silicone oil in the surface-treated inorganic particles was extracted under the conditions of an extraction time of 60 minutes and a rinsing time of 30 minutes. The carbon contents of the surface-treated inorganic particles before and after extraction were measured using “EMIA-110” manufactured by Horiba, Ltd. The content of the free silicone oil based on the total amount of the surface-treated inorganic particles was calculated by subtracting the carbon content of the surface-treated inorganic particles after extraction and removal of the free silicone oil from the carbon content of the surface-treated inorganic particles before extraction.

TABLE 1

| | External additive | | | | | | | | | | |
|---|---|---|---|---|---|---|---|---|---|---|---|
| | | | | | | | | | Physical property value | | |
| | Inorganic particles | | | Surface treating agent | | | | | | | Free |
| | | | Amount of | | (Weight | Amount of | Treatment | | | hydro- | silicone |
| External | | Particle | addition | | average) | addition | conditions | | HSP | phobization | oil |
| additive | | diameter | [parts by | | molecular | [parts by | Temperature | Time | value | degree | content |
| No. | Type | [nm] | mass] | Type | weight | mass] | [° C.] | [min] | (HSP2) | [%] | [ppm] |
| External | AEROSIL50 | 30 | 100 | DMO-SiOH1 | 7000 | 6 | 300 | 180 | 12.4 | 98 | 500 |
| additive 1 | | | | | | | | | | | |
| External | AEROSIL50 | 30 | 100 | PDMS | 7000 | 3 | 280 | 30 | 12.7 | 82 | 14000 |
| additive 2 | | | | | | | | | | | |
| External | AEROSIL50 | 30 | 100 | DMO-SiOH1 | 7000 | 6 | 340 | 180 | 12.4 | 100 | 10 |
| additive 3 | | | | | | | | | | | |
| External | AEROSIL50 | 30 | 100 | DMO-SiOH2 | 1200 | 6 | 300 | 180 | 12.4 | 98 | 500 |
| additive 4 | | | | | | | | | | | |
| External | AEROSIL50 | 30 | 100 | DMO-SiOH3 | 19000 | 6 | 300 | 180 | 12.4 | 98 | 500 |
| additive 5 | | | | | | | | | | | |
| External | AEROSIL40 | 100 | 100 | DMO-SiOH1 | 7000 | 5 | 300 | 180 | 12.4 | 98 | 500 |
| additive 6 | | | | | | | | | | | |
| External | AEROSIL200 | 12 | 100 | DMO-SiOH1 | 7000 | 10 | 300 | 180 | 12.4 | 98 | 500 |
| additive 7 | | | | | | | | | | | |
| External | AEROSIL50 | 30 | 100 | HMDS | 162 | 4 | 300 | 100 | 13.6 | 90 | 0 |
| additive 8 | | | | | | | | | | | |
| External | AEROSIL50 | 30 | 100 | Octyltri- | 234 | 4 | 300 | 150 | 15.0 | 95 | 0 |
| additive 9 | | | | methoxysilane | | | | | | | |
| External | AEROSIL50 | 30 | 100 | DMO-SiOH1 | 7000 | 2 | 280 | 20 | 12.4 | 75 | 500 |
| additive 10 | | | | | | | | | | | |

### 3. Preparation of Toner Base Particle

3-1. Preparation of Binder Resin Fine Particle Dispersion Liquid Containing Amorphous Resin, which Forms Core

### [Preparation of Binder Resin Fine Particle Dispersion Liquid 1] (First Stage Polymerization)

In a 5 L reaction vessel equipped with a stirrer, a temperature sensor, a cooling pipe, and a nitrogen introducing device, 8 g of sodium dodecylsulfate dissolved in 3 L of ion-exchanged water was prepared. While stirring at the 230 rpm stirring speed under a nitrogen gas stream, the internal temperature was raised to 80° C., and then a solution of 10 g of potassium persulfate in ion-exchanged water 200 g was added. The liquid temperature was again set to 80° C., and a monomer consisting of 480 g of styrene, 250 g of n-butyl acrylate, and 68 g of methacrylic acid was added dropwise over 1 hour, followed by heating and stirring at 80° C. for 2 hours to perform polymerization, thereby obtaining a resin fine particle dispersion liquid (a1).

### (Second Stage Polymerization)

A solution of 9.2 g of sodium dodecyl ether sulfate dissolved in 1500 ml of ion-exchanged water was prepared in a 5 L reaction vessel equipped with a stirrer, a temperature sensor, a cooling pipe, and a nitrogen introducing device. The solution was heated to 98° C., and then a mixed solution prepared by dissolving and mixing 210.5 g of the above-described fine resin particles (a1), a monomer mixture composed of 241 g of styrene, 75.0 g of 2-ethylhexyl acrylate, and 32.0 g of an 80% solution of methacrylic acid, 3.9 g of n-octyl mercaptan, and 104 g of behenyl behenate at 90° C. was added thereto. The materials were mixed and dispersed for 1 hour with “CLEARMIX” manufactured by M Technique Co., Ltd., which is a mechanical disperser having a circulation path, to prepare a dispersion liquid containing emulsified particles (oil droplets). Next, an initiator solution in which potassium persulfate 4.5 g was dissolved in 85 ml of ion-exchanged water was added to the dispersion liquid, and the system was heated and stirred at 84° C. for 1 hr to perform polymerization, thereby obtaining a resin fine particle dispersion liquid (a2).

### (Third Stage Polymerization)

To the resin fine particles dispersion liquid (a2), a solution of 5.3 g of potassium persulfate dissolved in 115 ml of ion-exchanged water was added. To the mixture, under a temperature condition of 82° C., a mixed liquid of a monomer mixture composed of 368.3 g of styrene, 149.1 g of n-butyl acrylate, and 45 g of an 80% solution of methacrylic acid, and 7.0 g of n-octyl mercaptan was added dropwise over 1 hour. After the completion of the dropwise addition, the mixture was heated and stirred for 2 hours for polymerization and then cooled to 28° C., thereby preparing a binder resin fine particle dispersion liquid 1 containing a styrene/acrylic copolymer resin.

The binder resin fine particles had a volume-based median diameter of 220 nm, a weight-average molecular weight of 30000, a glass transition point of 45° C., and a solid content of 30%.

### [Preparation of Binder Resin Fine Particle Dispersion Liquid 2]

A binder resin fine particle dispersion liquid 2 was obtained in the same manner as in the binder resin fine particle dispersion liquid 1 except that, in the second stage polymerization of the preparation step of the binder resin fine particle dispersion liquid 1, the type of wax was changed to paraffin wax (“HNP-0190”, product of NIPPON SEIRO CO., LTD).

The binder resin fine particles had a volume-based median diameter of 230 nm, a weight-average molecular weight (Mw) of 30000, a glass transition point of 45° C., and a solid content of 30%.

### [Preparation of Binder Resin Fine Particle Dispersion Liquid 3]

Binder resin fine particle dispersion liquid 3 was obtained in the same manner as in the binder resin fine particle dispersion liquid 1 except that, in the second stage polymerization in the preparation step of binder resin fine particle dispersion liquid 1, the type of wax was changed to diheptadecyl ketone.

The binder resin fine particles had a volume-based median diameter of 230 nm, a weight-average molecular weight (Mw) of 30000, a glass transition point of 45° C., and a solid content of 30%.

### [Preparation of Binder Resin Fine Particle Dispersion Liquid 4]

Binder resin fine particle dispersion liquid 4 was obtained in the same manner as in the binder resin fine particle dispersion liquid 1 except that, in the second stage polymerization in the preparation step of binder resin fine particle dispersion liquid 1, the type of wax was changed to stearyl stearamide.

The binder resin fine particles had a volume-based median diameter of 220 nm, a weight-average molecular weight (Mw) of 30000, a glass transition point of 45° C., and a solid content of 30%.

### [Preparation of Binder Resin Fine Particle Dispersion Liquid 5]

Binder resin fine particle dispersion liquid 5 was obtained in the same manner as in the binder resin fine particle dispersion liquid 1 except that, in the second stage polymerization in the preparation step of binder resin fine particle dispersion liquid 1, the type of wax was changed to pentaerythritol tetrabehenate.

The binder resin fine particles had a volume-based median diameter of 220 nm, a weight-average molecular weight (Mw) of 30000, a glass transition point of 45° C., and a solid content of 30%.

### [Method for Measuring Volume-Based Median Diameter of Binder Resin Fine Particles]

The volume-based median diameter of the binder resin fine particles was a value measured using “Microtrac UPA-150” manufactured by Nikkiso Co., Ltd.

### [Method for Measuring Weight-Average Molecular Weight of Binder Resin]

The weight-average molecular weight of the binder resin is a value measured by gel permeation chromatography (GPC). To be specific, an apparatus “HLC-8120GPC” (manufactured by Tosoh Corporation) and a column “TSK guard column+TSKgel SuperHZ-M3 series” (manufactured by Tosoh Corporation) are used. The measurement conditions were a column temperature of 40° C., a carrier-solvent of tetrahydrofuran (THF), and a carrier-solvent flow rate of 0.2 ml/min. A measurement sample was dissolved in tetrahydrofuran so as to have a concentration of 1 mg/ml under dissolution conditions in which the sample was treated for 5 minutes using an ultrasonic disperser at room temperature. A tetrahydrofuran solution of a measurement sample was treated with a filter having a pore size of 0.2 μm. Ten μL of this sample solution was injected into the device along with the carrier solvent described above and the detection was performed using a refractive index detector (RI detector). A calibration curve prepared using 10 samples of monodispersed polystyrene standard particles was used to calculate the weight-average molecular weight of the measurement sample in terms of polystyrene.

### [Method for Measuring Glass Transition Temperature of Binder Resin]

The glass transition point is a value measured using differential scanning calorimetry (e.g., “Diamond DSC” manufactured by PerkinElmer, Inc.). In a holder, 3.0 mg of the measurement sample sealed in an aluminum pan was set. An empty aluminum pan was used as a reference. The measurement conditions were a measurement temperature of 0° C. to 100° C. and a temperature increase rate of 10° C./min, and the analysis was performed based on the data during the temperature increase. An extended line of the base line before the rising of the first endothermic peak and a tangent line showing the maximum inclination between the rising portion of the first peak and the peak apex are drawn, and the intersection point thereof was used as the glass transition point.

### [Calculation of HSP Value of Wax Contained in Binder Resin Fine Particles]

The HSP value (HSP1) of the surface treating agent was calculated in the same manner as in the HSP value (HSP2) of the wax.

### 3-2. Preparation of Binder Resin Fine Particle Dispersion Liquid Containing Amorphous Resin Constituting Shell Portion (Hereinafter, Also Referred to as “Resin Fine Particle Dispersion Liquid for Shell”)

### [Preparation of Resin Fine Particle Dispersion Liquid for Shell 1]

### (Synthesis of Amorphous Polyester Resin)

In a reaction vessel equipped with a stirring device, a nitrogen inlet tube, a temperature sensor, and a rectifying column, 85 parts by mass of terephthalic acid and 18 parts by mass of fumaric acid as polycarboxylic acid, and 187 parts by mass of a bisphenol A propylene oxide adduct as a polyhydric alcohol were prepared. The temperature of the reaction system was increased to 190° C. over 1 hour, and after it was confirmed that the inside of the reaction system was uniformly stirred, Ti(OBu)₄ as a catalyst was added so as to be 0.006% by mass based on the total amount of the polycarboxylic acid. Further, the temperature of the reaction system was raised from the same temperature to 240° C. over 6 hours while distilling off the produced water. While maintained at 240° C., 32.3 parts by mass of stearyl alcohol subjected to a polymerization reaction by continuing a dehydration condensation reaction for 6 hours was added, and the mixture was reacted at a temperature of 200° C. for 1.5 hours under normal pressure to obtain an amorphous polyester resin 1. The amorphous polyester resin 1 had a weight-average molecular weight of 20000 and a glass transition point of 60° C.

### (Preparation of Resin Fine Particle Dispersion Liquid for Shell 1)

1200 parts by mass of the amorphous polyester resin was dissolved in 200 parts by mass of ethyl acetate, and while this solution was stirred, an aqueous solution prepared by dissolving sodium polyoxyethylene lauryl ether sulfate in 800 parts by mass of ion-exchanged water so as to have a concentration of 1% by mass was added dropwise. Ethyl acetate was removed from the solution under reduced pressure, and then the pH of the liquid was adjusted to pH 8.5 with ammonia. Thereafter, the solid content concentration was adjusted to 20% by mass. Thus, a resin fine particle dispersion liquid for shell 1 in which the amorphous polyester resin was dispersed in the aqueous medium was prepared. The volume-based median diameter of the resin fine particle dispersion liquid for shell 1 was 130 nm.

### [Methods for Measuring Physical Properties of Resin Fine Particles for Shell]

The weight-average molecular weight and glass transition temperature of the resin for shell and the volume-based median diameter of the shell resin fine particles are values measured by methods similar to those for the respective physical properties of the binder resin.

### 3-3. Preparation of Binder Resin Fine Particle Dispersion Liquid Containing Crystalline Polyester Resin (Hereinafter, Also Referred to as “Crystalline Polyester Resin Fine Particle Dispersion Liquid”)

### [Preparation of Crystalline Polyester Resin Fine Particle Dispersion Liquid 1]

### (Synthesis of Crystalline Polyester Resin 1)

In a 5 L reaction vessel equipped with a stirrer, a temperature sensor, a cooling pipe, and a nitrogen introducing device, 153 parts by mass of dodecanedioic acid as a polycarboxylic acid and 60 parts by mass of 1,4-butanediol as a polyhydric alcohol were prepared. The internal temperature was raised to 190° C. over 1 hour while stirring the components, and after a uniformly stirred state was confirmed, Ti(OBu)₄ as a catalyst was added in an amount of 0.003% by mass relative to the charged amount of the polycarboxylic acid. Thereafter, the internal temperature was raised from 190° C. to 240° C. over 6 hours while generated water was distilled off, and a dehydration condensation reaction was further continued for polymerization over 6 hours under the condition of a temperature of 240° C., thereby obtaining crystalline polyester resin 1. The crystalline polyester resin 1 had a melting point of 72° C. and a weight-average molecular weight of 15000.

### (Preparation of Crystalline Polyester Resin Fine Particle Dispersion Liquid 1)

In 200 parts by mass of ethyl acetate, 1200 parts by mass of a crystalline polyester resin was dissolved. While stirring this solution, an aqueous solution prepared by dissolving sodium polyoxyethylene lauryl ether sulfate in 800 parts by mass of ion-exchanged water so as to have a concentration of 1% by mass was added dropwise thereto. Ethyl acetate was removed from the solution under reduced pressure, and then the pH of the liquid was adjusted to pH 8.5 with ammonia. Thereafter, the solid content concentration was adjusted to 20% by mass. Thus, a crystalline polyester resin fine particle dispersion liquid 1 was prepared, in which fine particles of the crystalline polyester resin 1 were dispersed in the aqueous medium. The volume-based median diameter of the fine particles of the crystalline polyester resin 1 was 200 nm.

### [Method for Measuring Melting Point of Crystalline Polyester Resin Fine Particles]

The melting point of the crystalline polyester resin is a value measured as follows. The melting point is measured by differential scanning calorimetry using “DSC7000X” (manufactured by Hitachi-hightech, Ltd), which indicates the temperature at the top of the melting peak. Specifically, the melting temperature is measured by sealing 1.0 mg of a measurement sample in an aluminum pan (KITNO. B0143013), setting the pan in a sample holder of “DSC7000X”, and performing measurement at a measurement temperature of 0 to 100° C. and a temperature increase rate of 10° C./min, the values were analyzed based on the data obtained by the heating.

### [Methods for Measuring Other Physical Properties of Crystalline Polyester Resin Fine Particles]

The weight-average molecular weight of the crystalline polyester resin and the volume-based median diameter of the crystalline polyester resin fine particles are values measured by the same methods as for the respective physical properties of the binder resin.

### 3-4. Preparation of Colorant Fine Particle Dispersion Liquid

Ninety (90) parts by mass of sodium dodecyl sulfate was added to 1600 parts by mass of ion-exchanged water. While this solution was stirred, 420 parts by mass of carbon black (Regal 330R, manufactured by Cabot Corp.) was gradually added. Next, a dispersion treatment was performed using a stirring apparatus “CLEARMIX” manufactured by M Technique Co., Ltd., thereby preparing a colorant fine particle dispersion liquid. The average particle diameter (volume-based median diameter) of the colorant fine particles was 110 nm.

### [Method for Measuring Volume-Based Median Diameter of Colorant Fine Particles]

The volume-based median diameter of the colorant fine particles is a value measured using “NANOTRAC Wave II” (manufactured by Microtrac), which is a particle size measurement apparatus using a dynamic light scattering method.

### 3-5. Preparation of Toner Base Particle

Toner base particles 1 to 8 were prepared as described below. A list of the configurations is given in Table 2.

### [Production of Toner Base Particle 1]

In a Zebra flask equipped with a stirrer, a temperature sensor, a cooling pipe, and a nitrogen introducing device, 1,600 parts by mass of binder resin fine particle dispersion liquid 1, 300 parts by mass of the crystalline polyester resin fine particle dispersion liquid 1, 1,500 parts by mass of ion-exchanged water, and 500 parts by mass of colorant fine particle dispersion liquid were prepared. After the liquid temperature was adjusted to 25° C., an aqueous sodium hydroxide solution having a concentration of 25% by mass was added to adjust the pH to 10.

Next, an aqueous solution prepared by dissolving 54.3 parts by mass of magnesium chloride hexahydrate in 54.3 parts by mass of ion-exchanged water was added. Thereafter, the temperature of the system was raised to 97° C. to initiate an aggregation reaction between the resin fine particles and the colorant fine particles.

After the start of the aggregation reaction, sampling was periodically performed, the volume-based median diameter of the particles was measured using a particle size distribution measuring apparatus “Coulter Multisizer 3” manufactured by Beckman Coulter, Inc, and the particles were aggregated while stirring was continued until the volume-based median diameter reached 6.3 μm.

Next, 300 parts by mass of the resin fine particle dispersion liquid for shell 1 was added to adhere the shell to the surface of the core particles.

Thereafter, an aqueous solution prepared by dissolving 11.5 parts by mass of sodium chloride in 46 parts by mass of ion-exchanged water was added thereto. The temperature of the system was set to 95° C. and stirring was continued for 4 hours, and when the circularity measured by “FPIA-2100” manufactured by Sysmex Corporation, which is a flow-type particle-image analyzer, reached 0.946, cooling was performed to 25° C. under the condition of 6° C./min to stop the reaction.

After the cooling, the temperature of the dispersion liquid of toner base particles was increased again to 60° C. under the condition of 6° C./min, and held for 3 hours, thereby promoting crystallization of the crystalline polyester. Thereafter, the reaction was stopped by cooling at 6° C./min to obtain dispersion liquid of toner base particles.

The cooled toner base particles had a particle diameter of 6.1 μm and a circularity of 0.970.

The thus obtained dispersion liquid of toner base particles was subjected to solid-liquid separation using a basket-type centrifuge “MARK III, Model No. 60×40” manufactured by Matsumoto Kikai Co., Ltd., to form a wet cake. This wet cake was repeatedly subjected to washing and solid-liquid separation with the basket type centrifuge until the electrical conductivity of the filtrate became 15 μS/cm. Thereafter, the wet cake was subjected to a drying treatment by blowing an airflow having a temperature of 40° C. and a humidity of 20% RH thereon using “Flash Jet Dryer” (manufactured by Seishin Enterprise Co., Ltd.) until the moisture amount became 0.5% by mass. Cooling to 24° C. yielded toner base particles 1. The toner base particles 1 had a volume-based median diameter of 6.1 μm and an average circularity of 0.970.

### [Production of Toner Base Particle 2]

Toner base particles 2 was obtained in the same manner as in the toner base particles 1 except that the binder resin fine particle dispersion liquid was changed to the binder resin fine particle dispersion liquid 2. The toner particles had a particle diameter of 6.1 μm and a circularity of 0.968.

### [Preparation of Toner Base Particle 3]

Toner base particles 3 were obtained in the same manner as in the toner base particles 1 except that the binder resin fine particle dispersion liquid was changed to the binder resin fine particle dispersion liquid 3. The toner base particles had a particle diameter of 6.2 μm and a circularity of 0.968.

### [Preparation of Toner Base Particle 4]

Toner base particles 4 were obtained in the same manner as in the toner base particles 1 except that the binder resin fine particle dispersion liquid was changed to the binder resin fine particle dispersion liquid 4. The toner particles had a particle diameter of 6.1 μm and a circularity of 0.968.

### [Preparation of Toner Base Particle 5]

Toner base particles 5 were obtained in the same manner as in the toner base particles 1 except that the binder resin fine particle dispersion liquid was changed to the binder resin fine particle dispersion liquid 5. The toner particles had a particle diameter of 6.1 μm and a circularity of 0.968.

### [Preparation of Toner Base Particle 6]

Toner base particles 6 were obtained in the same manner as in the toner base particles 1 except that the amount of the binder resin fine particle dispersion liquid 1 added was changed to 1690 g and the amount of the crystalline polyester resin fine particle dispersion liquid 1 added was changed to 165 g. The toner particles had a particle diameter of 6.1 μm and a circularity of 0.968.

### [Preparation of Toner Base Particle 7]

Toner base particles 7 were obtained in the same manner as in the toner base particles 1 except that the amount of the binder resin fine particle dispersion liquid 1 added was changed to 1410 g and the amount of the crystalline polyester resin fine particle dispersion liquid 1 added was changed to 585 g. The toner particles had a particle diameter of 6.1 μm and a circularity of 0.968.

### [Production of Toner Base Particle 8]

Toner base particles 8 were obtained in the same manner as in the toner base particles 1 except that the amount of the binder resin fine particle dispersion liquid 1 added was changed to 1800 g and the amount of the crystalline polyester resin fine particle dispersion liquid 1 added was changed to 0 g. The toner particles had a particle diameter of 6.1 μm and a circularity of 0.968.

### [Method of Measuring Particle Diameter of Toner Base Particles]

The volume-based median diameter of the toner is a value measured and calculated using a measurement apparatus in which a computer system equipped with data processing software “Software V3.51” is connected to “Multisizer 3” manufactured by Beckman Coulter, Inc. To be specific, 0.02 g of the measurement sample was added to and blended with 20 mL of a surfactant (a surfactant solution obtained by diluting a neutral detergent containing a surfactant ingredient with pure water by a factor of 10 for the purpose of dispersing toner base particles), and then ultrasound dispersion was performed for 1 minute to prepare a toner dispersion liquid. The toner dispersion liquid was pipetted into the beaker containing “ISOTONII” (manufactured by Beckman Coulter, Inc.) in a sample stand until the display concentration on the measurement apparatus reached 8%. The measurement conditions were a measurement particle count of 25000 and an aperture diameter of 100 μm. The range of 2 μm to 60 μm, namely a measurement range, was divided into 256 parts to calculate frequency values, and the particle size of the largest 50% of the volume cumulative fraction was taken as the volume-based median diameter.

### [Method for Measuring Circularity of Toner Base Particle]

The average circularity of the toner is a value measured using “FPIA-3000” manufactured by Sysmex Corporation. Specifically, the measurement sample was wetted with an aqueous solution containing a surfactant, subjected to ultrasound dispersion treatment for 1 minute for dispersion, and then an image is captured using “FPIA-3000” manufactured by Sysmex Corporation under measurement conditions of an HPF (high-power field imaging) mode at an appropriate density with an HPF detection number of 3000 to 10000. The average circularity is a value calculated by calculating the circularity of individual toner base particles according to the following expression (y), adding the circularities of the respective toner base particles, and dividing the sum by the total number of toner base particles.

$$Circularity = ( Perimeter of circle having the same projected area as particle image ) / ( Perimeter of particle projection image ) \qquad Expression ( y )$$

TABLE 2

| | Binder resin fine particle | | | Content of each resin when binder | |
|---|---|---|---|---|---|
| | dispersion liquid No. (dispersion | | | resin is 100 parts by mass | |
| | liquid containing resin compatible | | Resin fine particle | Crystalline | |
| Toner base particle | with crystalline polyester resin, | Crystalline polyester | dispersion liquid for | polyester content | Wax content |
| No. | which forms core) | resin dispersion No. | shell No. | [parts by mass] | [parts by mass] |
| Toner base particle 1 | Binder resin fine particle | Crystalline polyester | Resin fine particle | 10.0 | 8.0 |
| | dispersion liquid 1 | resin dispersion liquid 1 | dispersion liquid for | | |
| | | | shell 1 | | |
| Toner base particle 2 | Binder resin fine particle | Crystalline polyester | Resin fine particle | 10.0 | 8.0 |
| | dispersion liquid 2 | resin dispersion liquid 1 | dispersion liquid for | | |
| | | | shell 1 | | |
| Toner base particle 3 | Binder resin fine particle | Crystalline polyester | Resin fine particle | 10.0 | 8.0 |
| | dispersion liquid 3 | resin dispersion liquid 1 | dispersion liquid for | | |
| | | | shell 1 | | |
| Toner base particle 4 | Binder resin fine particle | Crystalline polyester | Resin fine particle | 10.0 | 8.0 |
| | dispersion liquid 4 | resin dispersion liquid 1 | dispersion liquid for | | |
| | | | shell 1 | | |
| Toner base particle 5 | Binder resin fine particle | Crystalline polyester | Resin fine particle | 10.0 | 8.0 |
| | dispersion liquid 5 | resin dispersion liquid 1 | dispersion liquid for | | |
| | | | shell 1 | | |
| Toner base particle 6 | Binder resin fine particle | Crystalline polyester | Resin fine particle | 5.5 | 8.5 |
| | dispersion liquid 4 | resin dispersion liquid 1 | dispersion liquid for | | |
| | | | shell 1 | | |
| Toner base particle 7 | Binder resin fine particle | Crystalline polyester | Resin fine particle | 19.5 | 7.1 |
| | dispersion liquid 4 | resin dispersion liquid 1 | dispersion liquid for | | |
| | | | shell 1 | | |
| Toner base particle 8 | Binder resin fine particle | — | Resin fine particle | 0.0 | 9.0 |
| | dispersion liquid 4 | | dispersion liquid for | | |
| | | | shell 1 | | |

### 4. Preparation of Toner

### [Preparation of Toner 1]

To 100 parts by mass of the toner base particle 1, 1.50 parts by mass of the external additive 1 and 0.20 parts by mass of the external additive 2 were added. The materials were mixed using the Henschel mixer for 20 minutes under the condition of a circumferential speed of rotor blades of 40 m/s and were further allowed to pass through a 400 mesh sieve to obtain toner 1.

### [Preparation of Toner 2]

Toner particles 2 were obtained in the same manner as in the toner 1 except that the toner base particles were changed to the toner base particles 2.

### [Preparation of Toner 3]

Toner particles 3 were obtained in the same manner as in the toner 1 except that the toner base particles were changed to the toner base particles 3.

### [Preparation of Toner 4]

Toner 4 was obtained in the same manner as in toner 1 except that the toner base particles were changed to toner base particles 4, and the external additive 8 was changed to external additive 9.

### [Preparation of Toner 5]

Toner 5 was obtained in the same manner as in toner 4 except that the toner base particles were changed to toner base particle 5.

### [Preparation of Toner 6]

Toner 6 was obtained in the same manner as in toner 4 except that external additive 1 was changed to external additive 2.

### [Preparation of Toner 7]

Toner 7 was obtained in the same manner as in toner 4 except that external additive 1 was changed to external additive 3.

### [Preparation of Toner 8]

Toner 8 was obtained in the same manner as in toner 4 except that external additive 1 was changed to external additive 4.

### [Preparation of Toner 9]

Toner 9 was obtained in the same manner as in toner 4 except that external additive 1 was changed to external additive 5.

### [Preparation of Toner 10]

Toner 10 was obtained in the same manner as in toner 4 except that toner base particles 4 were changed to toner base particles 6.

### [Preparation of Toner 11]

Toner 11 was obtained in the same manner as in the case of toner 4 except that toner base particles 4 were changed to toner base particles 7.

### [Preparation of Toner 12]

Toner 12 was obtained in the same manner as in toner 4 except that external additive 1 was changed to external additive 6.

### [Preparation of Toner 13]

Toner 13 was obtained in the same manner as in toner 4 except that external additive 1 was changed to external additive 7.

### [Preparation of Toner 14]

Toner 14 was obtained in the same manner as in toner 4 except that the amount of external additive 1 added was changed to 0.70 parts by mass.

### [Preparation of Toner 15]

Toner 15 was obtained in the same manner as in toner 4 except that the amount of external additive 1 added was changed to 2.00 parts by mass.

### [Preparation of Toner 16]

Toner 16 was obtained in the same manner as in toner 4 except that the amount of external additive 1 added was changed to 0.25 parts by mass.

### [Preparation of Toner 17]

Toner 17 was obtained in the same manner as in toner 4 except that the amount of external additive 1 added was changed to 3.00 parts by mass.

### [Preparation of Toner 18]

Toner 18 was obtained in the same manner as in toner 2 except that the amount of external additive 1 added was changed to 0.20 parts by mass and the amount of external additive 8 added was changed to 1.50 parts by mass.

### [Preparation of Toner 19]

Toner 19 was obtained in the same manner as in toner 18 except that external additive 8 was changed to external additive 9.

### [Preparation of Toner 20]

Toner 20 was obtained in the same manner as in toner 18 except that external additive 8 was changed to external additive 10.

### [Preparation of Toner 21]

Toner 21 was obtained in the same manner as in the case of toner 4 except that toner base particles 4 were changed to toner base particles 8.

### 5. Preparation of Developer

Developers 1 to 21 were prepared by adding, to each of the toners 1 to 21, a ferrite carrier coated with a silicone resin and having a volume-based median diameter of 60 μm such that the toner concentration was 6% by mass, and mixing the mixture using a V-type mixer.

### 6. Evaluation

The toners 1 to 21 were evaluated as follows. The results are shown in Table 3, 4 below.

### 6-1. Evaluation of Low-Temperature Fixability/U.O

A fixing apparatus of “bizhub PRESS (registered trademark) C1070” manufactured by Konica Minolta Inc., which is a multi-functional peripheral, modified so that surface temperature of an upper fixing belt and a lower fixing roller can be changed was used. The above apparatus was modified so that the fixing temperature, the amount of toner adhesion, and the system speed can be set at any values.

Under an environment of normal temperature and humidity (temperature: 20° C., relative humidity: 50% RH), the adhesion amount was set to 11.3 g/m² on A4 size high-quality paper “NPI High-Quality (127.9 g/m²)” manufactured by Nippon Paper Industries Co., Ltd. Thereafter, a fixing experiment for fixing an image of a 100 mm×100 mm size was repeatedly performed up to 180° C. while changing the set fixing temperature from 120° C. so as to increase in increments of 1° C. The minimum fixing temperature at which no image contamination due to fixing offset was visually observed was defined as the minimum fixing temperature (U. O. avoidance temperature). A lower minimum fixing temperature indicates a better result, and a minimum fixing temperature of less than 140° C. was regarded as an acceptable level.

### 6-2. Gloss Unevenness

The copier was used, and glossy paper “POD Gloss Coat 128 (128 g/m²)” (manufactured by Oji Paper Co., Ltd.) was used as evaluation paper. A temperature (U. O. avoidance temperature+25° C.) increased by 25° C. from a temperature at which under-offset did not occur (U. O. avoidance temperature) was set as a fixing temperature, and the fixing roller was set to the fixing temperature. In addition, the pressure roller was set to 90° C., a solid image in which the toner amount on the transfer paper was set to 8.0 g/m² was continuously output on 10 sheets, and the gloss uniformity of the obtained image was evaluated.

The gloss uniformity of the image was evaluated according to the following evaluation criteria by comparing the gloss of the first image and the gloss of the last tenth image by visual observation and observation using a loupe. Rank 2 or higher is an acceptable level without any practical problem.

### (Evaluation Criterion)

Rank 4: at which no difference in gloss between the two images can be detected even when observed with a microscope at a magnification of 100 times
rank 3: at which no difference in gloss between the two images can be detected even when the images are enlarged with a 20-fold loupe and observed
Rank 2: although a slight difference in gloss between the two images can be detected when the images are enlarged with a 20-fold loupe, the difference cannot be detected at all by visual inspection, which is a level at which there is no problem with image quality
Rank 1: at which a difference in gloss between the two images can be visually detected

### 6-3. Evaluation of Heat-Resistant Storage Property

Toner 0.5 g was placed in a 10 ml glass bottle with a 21 mm inside diameter, the lid was closed, and the toner was shaken with “Tap Denser KYT-2000” (manufactured by Seishin Enterprise Co., Ltd.) at room temperature for 600 times. The bottles were left for 2 hours in an environment of three levels of temperatures of 57.5° C., 60.0° C., and 62.5° C. and 35% RH in a state where the lids were removed. Next, the toner was placed on a 48-mesh (opening of 350 μm) sieve with care not to crush toner aggregates, set in a powder tester (manufactured by Hosokawa Micron Corporation), fixed with a press bar and a knob nut, adjusted to a vibration strength of 1 mm in feed rate, and vibrated for 10 seconds. Thereafter, the ratio (% by mass) of the amount of the toner remaining on the sieve was measured.

The toner aggregation rate is a value calculated by the following formula.

$$Toner aggregation rate ( \% ) = Weight ( g ) of residual toner on sieve / 0.5 ( g ) \times 100$$

The toner aggregation rate is measured at the three levels of temperature, the temperature at which the aggregation rate reaches 50% is estimated, and this temperature is taken as the 50% aggregation temperature. The heat-resistant storage property (50% aggregation temperature) of the toner was evaluated according to the following standard. Note that a higher 50% aggregation temperature indicates a better result, and a temperature of 57.5° C. or higher was regarded as an acceptable level.

### 6-4. Evaluation of Fluidity

The fluidity of the toner was evaluated by bulk density. The bulk density of the toner was determined in the same manner as in the method described in Japanese Unexamined Patent Publication No. 2014-137518. That is, as shown in FIG. 1 of Japanese Unexamined Patent Publication No. 2014-137518, a cylindrical container with a capacity of 25 cm³ having a circular opening with a 28 mm diameter at the upper end was placed on a container base placed on a horizontal plane. By a funnel holding portion of a stand provided on the container base, a funnel including a discharge port with a caliber of 2.5 mm at a lower end was held at a position where a distance from an opening of the container to a tip of the discharge port of the funnel is 25 mm, directly above the cylindrical container. Next, the measurement target toner was discharged and dropped from a discharge port of the funnel and was poured into a cylindrical container from an opening thereof until the toner overflows from the opening of the container. After the raised sample portion was removed by leveling the toner horizontally along the surface of the opening of the container, the mass of the toner filling the container was measured. From the measurement value, the bulk density d (g/cm³) of the toner is determined by the following expression (B). Note that a higher value of the bulk density of the toner indicates a better result, and a 0.350 g/cm³ or higher value is determined as an acceptable level.

$$d = ( mass ( g ) of sample in container ) / ( volume of container ( {cm}^{3} ) ) \qquad Expression ( B )$$

TABLE 3

| | Toner | | | | | | | | |
|---|---|---|---|---|---|---|---|---|---|
| | | External additive | | | | | | | |
| | | Type/amount of external | | Type/amount of external | | | | | |
| | | additive (first type) | | additive (second type) | | | | | |
| | | | Amount per | | Amount per | | | | |
| | | | 100 parts by | | 100 parts by | | | Free | Base particle |
| | | | mass of base | | mass of base | hydro- | | silicone | Toner |
| | | | particles | | particles | phobization | HSP | oil | base |
| | Toner | | [parts by | | [parts by | degree | value | amount | particle |
| | no. | Type | mass] | Type | mass] | [%] | (HSP2) | [ppm] | no. |
| Ex. 1 | Toner 1 | External | 1.50 | External | 0.20 | 98 | 12.4 | 500 | Base |
| | | additive 1 | | additive 8 | | | | | particle 1 |
| Ex. 2 | Toner 2 | External | 1.50 | External | 0.20 | 98 | 12.4 | 500 | Base |
| | | additive 1 | | additive 8 | | | | | particle 2 |
| Ex. 3 | Toner 3 | External | 1.50 | External | 0.20 | 98 | 12.4 | 500 | Base |
| | | additive 1 | | additive 8 | | | | | particle 3 |
| Ex. 4 | Toner 4 | External | 1.50 | External | 0.20 | 98 | 12.4 | 500 | Base |
| | | additive 1 | | additive 9 | | | | | particle 4 |
| Ex. 5 | Toner 5 | External | 1.50 | External | 0.20 | 98 | 12.4 | 500 | Base |
| | | additive 1 | | additive 9 | | | | | particle 5 |
| Ex. 6 | Toner 6 | External | 1.50 | External | 0.20 | 82 | 12.7 | 14000 | Base |
| | | additive 2 | | additive 9 | | | | | particle 4 |
| Ex. 7 | Toner 7 | External | 1.50 | External | 0.20 | 100 | 12.4 | 10 | Base |
| | | additive 3 | | additive 9 | | | | | particle 4 |
| Ex. 8 | Toner 8 | External | 1.50 | External | 0.20 | 98 | 12.4 | 500 | Base |
| | | additive 4 | | additive 9 | | | | | particle 4 |
| Ex. 9 | Toner 9 | External | 1.50 | External | 0.20 | 98 | 12.4 | 500 | Base |
| | | additive 3 | | additive 9 | | | | | particle 4 |
| Ex. 10 | Toner 10 | External | 1.50 | External | 0.20 | 98 | 12.4 | 500 | Base |
| | | additive 1 | | additive 9 | | | | | particles 6 |
| Ex. 11 | Toner 11 | External | 1.50 | External | 0.20 | 98 | 12.4 | 500 | Base |
| | | additive 1 | | additive 9 | | | | | particles 7 |

Toner
Base particle

| | |
|---|---|
| Crystalline | |
| polyester | |
| resin | Wax |

| | Content | | Content | | | Evaluation result | | | |
|---|---|---|---|---|---|---|---|---|---|
| | based on | | based on | | | | | Heat- | |
| | total resin | | total resin | | | Low- | | resistant | |
| | amount | | amount | HSP | | temperature | | storage | |
| | [parts by | | [parts by | value | HSP1 − | fixability | Gloss | property | Fluidity |
| | mass] | Type | mass] | (HSP1) | HSP2 | [° C.] | unevenness | [° C.] | [g/cm³] |
| Ex. 1 | 10.0 | Behenyl | 8.0 | 16.2 | 3.8 | 131 | 3 | 62.3 | 0.395 |
| | | behenate | | | | | | | |
| Ex. 2 | 10.0 | Paraffin wax | 8.0 | 16.0 | 3.6 | 131 | 3 | 62.3 | 0.394 |
| Ex. 3 | 10.0 | Diheptadecyl | 8.0 | 16.2 | 3.8 | 132 | 3 | 62.2 | 0.395 |
| | | ketone | | | | | | | |
| Ex. 4 | 10.0 | Stearyl | 8.0 | 16.9 | 4.5 | 131 | 4 | 62.3 | 0.395 |
| | | stearamide | | | | | | | |
| Ex. 5 | 10.0 | Pentaerythritol | 8.0 | 16.2 | 3.8 | 131 | 4 | 62.3 | 0.396 |
| | | tetrabehenate | | | | | | | |
| Ex. 6 | 10.0 | Stearyl | 8.0 | 16.9 | 4.2 | 132 | 2 | 57.8 | 0.360 |
| | | stearamide | | | | | | | |
| Ex. 7 | 10.0 | Stearyl | 8.0 | 16.9 | 4.5 | 131 | 4 | 62.5 | 0.410 |
| | | stearamide | | | | | | | |
| Ex. 8 | 10.0 | Stearyl | 8.0 | 16.9 | 4.5 | 131 | 4 | 58.8 | 0.353 |
| | | stearamide | | | | | | | |
| Ex. 9 | 10.0 | Stearyl | 8.0 | 16.9 | 4.5 | 131 | 3 | 62.5 | 0.406 |
| | | stearamide | | | | | | | |
| Ex. 10 | 5.5 | Stearyl | 8.0 | 16.9 | 4.5 | 137 | 4 | 64.0 | 0.400 |
| | | stearamide | | | | | | | |
| Ex. 11 | 19.5 | Stearyl | 8.0 | 16.9 | 4.5 | 126 | 3 | 57.7 | 0.355 |
| | | stearamide | | | | | | | |

TABLE 4

| | Toner | | | | | | | | |
|---|---|---|---|---|---|---|---|---|---|
| | | External additive | | | | | | | |
| | | Type/amount of external | | Type/amount of external | | | | | |
| | | additive (first type) | | additive (second type) | | | | | |
| | | | Amount per | | Amount per | | | | |
| | | | 100 parts by | | 100 parts by | | | Free | Base particle |
| | | | mass of base | | mass of base | hydro- | | silicone | Toner |
| | | | particles | | particles | phobization | HSP | oil | base |
| | Toner | | [parts by | | [parts by | degree | value | amount | particle |
| | no. | Type | mass] | Type | mass] | [%] | (HSP2) | [ppm] | no. |
| Ex. 12 | Toner 12 | External | 1.50 | External | 0.20 | 98 | 12.4 | 500 | Base |
| | | additive 6 | | additive 9 | | | | | particle 4 |
| Ex. 13 | Toner 13 | External | 1.50 | External | 0.20 | 98 | 12.4 | 500 | Base |
| | | additive 7 | | additive 9 | | | | | particle 4 |
| Ex. 14 | Toner 14 | External | 0.70 | External | 0.20 | 98 | 12.4 | 500 | Base |
| | | additive 1 | | additive 9 | | | | | particle 4 |
| Ex. 15 | Toner 15 | External | 2.00 | External | 0.20 | 98 | 12.4 | 500 | Base |
| | | additive 1 | | additive 9 | | | | | particle 4 |
| Ex. 16 | Toner 16 | External | 0.25 | External | 0.20 | 98 | 12.4 | 500 | Base |
| | | additive 1 | | additive 9 | | | | | particle 4 |
| Ex. 17 | Toner 17 | External | 3.00 | External | 0.20 | 98 | 12.4 | 500 | Base |
| | | additive 1 | | additive 9 | | | | | particle 4 |
| Comp. Ex. 1 | Toner 18 | External | 1.50 | External | 0.20 | 90 | 13.6 | 0 | Base |
| | | additive 8 | | additive 1 | | | | | particle 2 |
| Comp. Ex. 2 | Toner 19 | External | 1.50 | External | 0.20 | 95 | 15.0 | 0 | Base |
| | | additive 9 | | additive 1 | | | | | particle 2 |
| Comp. Ex. 3 | Toner 20 | External | 1.50 | External | 0.20 | 75 | 12.4 | 500 | Base |
| | | additive 10 | | additive 1 | | | | | particle 4 |
| Comp. Ex. 4 | Toner 21 | External | 1.50 | External | 0.20 | 98 | 12.4 | 500 | Base |
| | | additive 1 | | additive 9 | | | | | particles 8 |

| | Toner | | | | | | | | |
|---|---|---|---|---|---|---|---|---|---|
| | Base particle | | | | | | | | |
| | Crystalline | | | | | | | | |
| | polyester | | | | | | | | |
| | resin | Wax | | | | | | | |
| | Content | | Content | | | Evaluation result | | | |
| | based on | | based on | | | | | Heat- | |
| | total resin | | total resin | | | Low- | | resistant | |
| | amount | | amount | HSP | | temperature | | storage | |
| | [parts by | | [parts by | value | HSP1 − | fixability | Gloss | property | Fluidity |
| | mass] | Type | mass] | (HSP1) | HSP2 | [° C.] | unevenness | [° C.] | [g/cm³] |
| Ex. 12 | 10.0 | Stearyl | 8.0 | 16.9 | 4.5 | 132 | 4 | 64.0 | 0.353 |
| | | stearamide | | | | | | | |
| Ex. 13 | 10.0 | Stearyl | 8.0 | 16.9 | 4.5 | 132 | 2 | 57.9 | 0.420 |
| | | stearamide | | | | | | | |
| Ex. 14 | 10.0 | Stearyl | 8.0 | 16.9 | 4.5 | 128 | 2 | 58.2 | 0.363 |
| | | stearamide | | | | | | | |
| Ex. 15 | 10.0 | Stearyl | 8.0 | 16.9 | 4.5 | 132 | 4 | 64.5 | 0.425 |
| | | stearamide | | | | | | | |
| Ex. 16 | 10.0 | stearyl | 8.0 | 16.9 | 4.5 | 129 | 2 | 57.5 | 0.350 |
| | | stearamide | | | | | | | |
| Ex. 17 | 10.0 | Stearyl | 8.0 | 16.9 | 4.5 | 139 | 4 | 65.5 | 0.430 |
| | | stearamide | | | | | | | |
| Comp. Ex. 1 | 10.0 | Paraffin wax | 8.0 | 16.0 | 2.4 | 132 | 1 | 61.5 | 0.387 |
| Comp. Ex. 2 | 10.0 | Paraffin wax | 8.0 | 16.0 | 1.0 | 132 | 1 | 60.5 | 0.370 |
| Comp. Ex. 3 | 10.0 | Stearyl | 8.0 | 16.9 | 4.5 | 132 | 1 | 57.7 | 0.346 |
| | | stearamide | | | | | | | |
| Comp. Ex. 4 | 0.0 | Stearyl | 8.0 | 16.9 | 4.5 | 150 | 4 | 65.0 | 0.410 |
| | | stearamide | | | | | | | |

Note that the hydrophobization degree and the amount of free silicone oil listed in Table 3, 4 refer to the hydrophobization degree and the amount of free silicone oil of the surface-treated inorganic particles having the highest content on a mass basis among the two types of surface-treated inorganic particles. Similarly, the HSP value (HSP2) of the surface treating agent refers to the HSP value of the surface treating agent contained in the surface-treated inorganic particles having the highest content on a weight basis among the two types of surface-treated inorganic particles. In addition, the content of the crystalline polyester and the wax refers to the ratio of the content mass when the total amount of the binder resin and the crystalline polyester resin (the total amount of the resins) is 100 parts by mass.

As described above, it is found that both low-temperature fixability and suppression of gloss unevenness are achieved in Examples 1 to 17 using a toner including, as the external additive, the inorganic particles surface-treated with the surface treating agent so that the hydrophobization degree is 80% or more, and having a difference between the HSP value of the wax and the HSP value of the surface treating agent set to be a predetermined value or more.

### INDUSTRIAL APPLICABILITY

According to the electrostatic charge image developing toner of the present invention, it is possible to achieve both low-temperature fixability and suppression of gloss unevenness of an obtained image. Therefore, the present invention is useful in the field of image formation.

Although embodiments of the present invention have been described and illustrated in detail, the disclosed embodiments are made for purposes of illustration and example only and not limitation. The scope of the present invention should be interpreted by terms of the appended claims.

What is claimed is:

1. An electrostatic charge image developing toner, comprising:
a toner base particle including a binder resin and a wax; and
an external additive adhering to a surface of the toner base particle, wherein
the binder resin includes a crystalline polyester resin and an amorphous resin,
the external additive includes an inorganic particle surface-treated with a surface treating agent,
a hydrophobization degree of the inorganic particle is 80% or more, and
an HSP value (HSP1) of the wax and an HSP value (HSP2) of the surface treating agent satisfy expression (A) below:
$$HSP 1 - HSP 2 \geq 2.7 . \qquad Expression ( A )$$

2. The electrostatic charge image developing toner according to claim 1, wherein:
the surface treating agent is silicone oil; and
a content of free silicone oil relative to a content mass of the surface-treated inorganic particle is 1 ppm to 15000 ppm.

3. The electrostatic charge image developing toner according to claim 2, wherein
the content of the free silicone oil relative to the content mass of the surface-treated inorganic particle is 1 ppm to 5000 ppm.

4. The electrostatic charge image developing toner according to claim 1, wherein
the surface treating agent has a weight-average molecular weight of 1000 to 20000.

5. The electrostatic charge image developing toner according to claim 1, wherein
the inorganic particle has a particle diameter of 10 nm to 150 nm.

6. The electrostatic charge image developing toner according to claim 1, wherein
a content of the crystalline polyester resin, based on a total mass of the toner base particle, is 5% by mass to 20% by mass.

7. The electrostatic charge image developing toner according to claim 1, wherein
a content of the external additive, based on a total mass of the toner base particle, is 0.3% by mass to 3.0% by mass.
